(19) United States
(12) Patent Application Publication
(10) Pub. No.: US 2011/0302116 A1
(43) Pub. Date: Dec. 8, 2011

(54) DATA PROCESSING DEVICE, DATA PROCESSING METHOD, AND PROGRAM

(76) Inventors: Naoki Ide, Tokyo (JP); Masato Ito, Tokyo (JP); Kohtaro Sabe, Tokyo (JP)

(21) Appl. No.: 13/116,940

(22) Filed: May 26, 2011

(30) Foreign Application Priority Data
Jun. 3, 2010 (JP) P2010-128068

(51) Int. Cl. G06F 15/18

(52) U.S. Cl. 706/12

(57) ABSTRACT

A data processing device including a learning section which expresses user movement history data obtained as learning data as a probability model which expresses activities of a user and learns parameters of the model; a destination and stopover estimation section which estimates a destination node and a stopover node from state nodes of the probability model; a current location estimation section which inputs the user movement history data in the probability model and estimates a current location node which is equivalent to the current location of the user; a searching section which searches for a route from the current location of the user to a destination using information on the estimated destination node and stopover node and the current location node and the probability model obtained by learning; and a calculating section which calculates an arrival probability and a necessary time to the searched destination.

### BACKGROUND OF THE INVENTION

1. Field of the Invention

The present invention relates to a data processing device, a data processing method, and a program, and in particular to a data processing device, a data processing method, and a program which are able to more accurately predict a route and a necessary time to a destination.

2. Description of the Related Art

In recent years, there has been active study into modeling and learning a state of a user using time series data obtained from a wearable sensor which is a sensor attached to the body of a user and recognizing the current state of a user using the model obtained from the learning (for example, Japanese Unexamined Patent Application Publication No. 2006-134080, Japanese Unexamined Patent Application Publication No. 2008-204040, and “Life Patterns: Structure from Wearable Sensors”, Brian Patrick Clarkson, Doctor Thesis, MIT, 2002).

Before this, as Japanese Patent Application No. 2009-180780, the applicants proposed a method for stochastically estimating a plurality of possibilities of an active state of a user in a desired future point in time. In Japanese Patent Application No. 2009-180780, an active state of a user is learnt as a stochastic state transition model from time series data and the current active state is recognized using the learnt stochastic state transition model, so that it is possible to stochastically predict the active state of a user “after a predetermined time”. In Japanese Patent Application No. 2009-180780, as an example of estimating the active state of a user “after a predetermined time”, an example is shown where the current position of a user is recognized using a stochastic state transition model, which is obtained by learning time series data of a movement history of a user, and the destination (location) of the user after a predetermined time is predicted.

Furthermore, the applicants further developed Japanese Patent Application No. 2009-180780, and as Japanese Patent Application No. 2009-208064, proposed a method where arrival probabilities, routes and times to a plurality of destinations are predicted even in a case where there is no specification of the passing of time from the current point in time such as “after a predetermined time”. In the method of Japanese Patent Application No. 2009-208064, an attribute of a “movement state” or a “stationary state” is given to nodes which configure a stochastic state transition model. Then, by finding the “stationary state” nodes which are destination nodes from the nodes which configure the stochastic state transition model, it is possible to automatically detect candidate destinations.

### SUMMARY OF THE INVENTION

However, in the prediction method of Japanese Patent Application No. 2009-208064, the following phenomena occur. Firstly, the predicted destination is not the actual destination but a stopover. According to this, a route from the stopover to the actual destination is not predicted (first problem). For example, there are cases where a location of being stationary for a predetermined time, due to transferring to another train at a station, stopping at a book store, and the like on the way home, is recognized as a destination and a route home, which is the proper destination, is not able to be predicted.

Secondly, a plurality of similar routes which pass through routes which are substantially the same are shown as an estimation result and other routes which are advantageous to a user are not shown to the user (second problem). This is caused by not being able to suitably distinguish routes which are frequently passed through and where there is often variation and routes which are not frequently passed through and where there is less variation.

It is desirable to be able to more accurately predict a route and a necessary time to a destination.

A data processing device according to an embodiment of the invention is provided with a learning means which expresses user movement history data obtained as learning data as a probability model which expresses activities of a user and learns parameters of the model; a destination and stopover estimation means which estimates a destination node and a stopover node which are equivalent to a destination and a stopover of a movement from state nodes of the probability model which uses the parameters obtained by learning; a current location estimation means which inputs the user movement history data, which is different to the learning data and is within a predetermined time from the current time, in the probability model which uses the parameters obtained by learning and estimates a current location node which is equivalent to the current location of the user; a searching means which searches for a route from the current location of the user to a destination using information on the estimated destination node and stopover node and the current location node and the probability model obtained by learning; and a calculating means which calculates an arrival probability and a necessary time to the searched destination.

A data processing method according to another embodiment of the invention of a data processing device which processes movement history data of a user which includes the steps of expressing the movement history data obtained as learning data as a probability model which expresses activities of a user and learning parameters of the model; estimating a destination node and a stopover node which are equivalent to a destination and a stopover of a movement from state nodes of the probability model which uses the parameters obtained by learning; inputting the user movement history data, which is different to the learning data and is within a predetermined time from the current time, in the probability model which uses the parameters obtained by learning and estimating a current location node which is equivalent to the current location of the user; searching for a route from the current location of the user to a destination using information on the estimated destination node and stopover node and the current location node and the probability model obtained by learning; and calculating an arrival probability and a necessary time to the searched destination.

A program according to still another embodiment of the invention makes a computer function as a learning means which expresses user movement history data obtained as learning data as a probability model which expresses activities of a user and learns parameters of the model; a destination and stopover estimation means which estimates a destination node and a stopover node which are equivalent to a destination and a stopover of a movement from state nodes of the probability model which uses the parameters obtained by learning; a current location estimation means which inputs the user movement history data, which is different to the learning data and is within a predetermined time from the current time, in the probability model which uses the parameters obtained by learning and estimates a current location node which is equivalent to the current location of the user; a searching means which searches for a route from the current location of the user to a destination using information on the estimated destination node and stopover node and the current location node and the probability model obtained by learning; and a calculating means which calculates an arrival probability and a necessary time to the searched destination.

According to the embodiments of the invention, user movement history data obtained as learning data is expressed as a probability model which expresses activities of a user and parameters of the model are learnt, a destination node and a stopover node which are equivalent to a destination and a stopover of a movement are estimated from state nodes of the probability model which uses the parameters obtained by learning, the user movement history data, which is different to the learning data and is within a predetermined time from the current time, is input in the probability model which uses the parameters obtained by learning and estimating a current location node which is equivalent to the current location of the user estimated, a route from the current location of the user to a destination is searched for using information on the estimated destination node and stopover node and the current location node and the probability model obtained by learning, and an arrival probability and a necessary time to the searched destination are calculated.

According to the embodiments of the invention, it is possible to more accurately predict a route and a necessary time to a destination.

### BRIEF DESCRIPTION OF THE DRAWINGS

FIG. 1 is a block diagram illustrating a configuration example of a prediction system according to an embodiment of the invention;

FIG. 2 is a block diagram illustrating a hardware configuration example of the prediction system;

FIG. 3 is a diagram illustrating an example of movement history data;

FIG. 4 is a diagram illustrating an example of an HMM;

FIG. 5 is a diagram illustrating an example of a left-to-right HMM;

FIGS. 6A and 6B are diagrams illustrating an example of an HMM where a sparse limitation is applied;

FIG. 7 is a block diagram illustrating a detailed configuration example of a learning pre-process section;

FIG. 8 is a diagram describing processing of a learning pre-process section;

FIG. 9 is a block diagram illustrating a detailed configuration example of a movement attribute distinction and application section;

FIG. 10 is a block diagram illustrating a configuration example of a learning unit of a movement attribute distinguishing section;

FIG. 11 is a diagram illustrating an attribute example in a case where behavior states are classified into each category;

FIG. 12 is a diagram describing a processing example of a behavior state labeling section;

FIG. 13 is a diagram describing a processing example of a behavior state labeling section;

FIG. 14 is a block diagram illustrating a configuration example of a behavior state learning section of FIG. 10;

FIG. 15 is a block diagram illustrating a detailed configuration example of a movement attribute distinguishing section;

FIG. 16 is a block diagram illustrating a different configuration example of a learning unit of a movement attribute distinguishing section;

FIG. 17 is a block diagram illustrating a different configuration example of a movement attribute distinguishing section;

FIG. 18 is a flow chart describing processing of a learning pre-process section;

FIG. 19 is a flow chart describing learning main process processing;

FIG. 20 is a block diagram illustrating a detailed configuration example of a learning post-process section;

FIG. 21 is a diagram describing correction processing of state series data of a state series correcting section;

FIG. 22 is a diagram describing correction processing of state series data of the state series correcting section;

FIG. 23 is a diagram describing correction processing of state series data of the state series correcting section;

FIG. 24 is a diagram describing correction processing of state series data of the state series correcting section;

FIG. 25 is a diagram describing correction processing of state series data of the state series correcting section;

FIGS. 26A to 26C are diagrams describing processing of a destination and stopover detection section;

FIG. 27 is a flow chart describing processing of an entire learning block;

FIG. 28 is a flow chart describing a tree search processing;

FIG. 29 is a diagram further describing a tree search processing;

FIGS. 30A to 30D are diagrams further describing a tree search processing;

FIG. 31 is a diagram illustrating an example of a search result list of a tree search processing;

FIG. 32 is a flow chart describing a representative route selection processing;

FIG. 33 is a flow chart describing processing of an entire prediction block; and

FIG. 34 is a block diagram illustrating a configuration example of a computer according to the embodiment of the invention.

### DESCRIPTION OF THE PREFERRED EMBODIMENTS

### Configuration Example of Prediction System

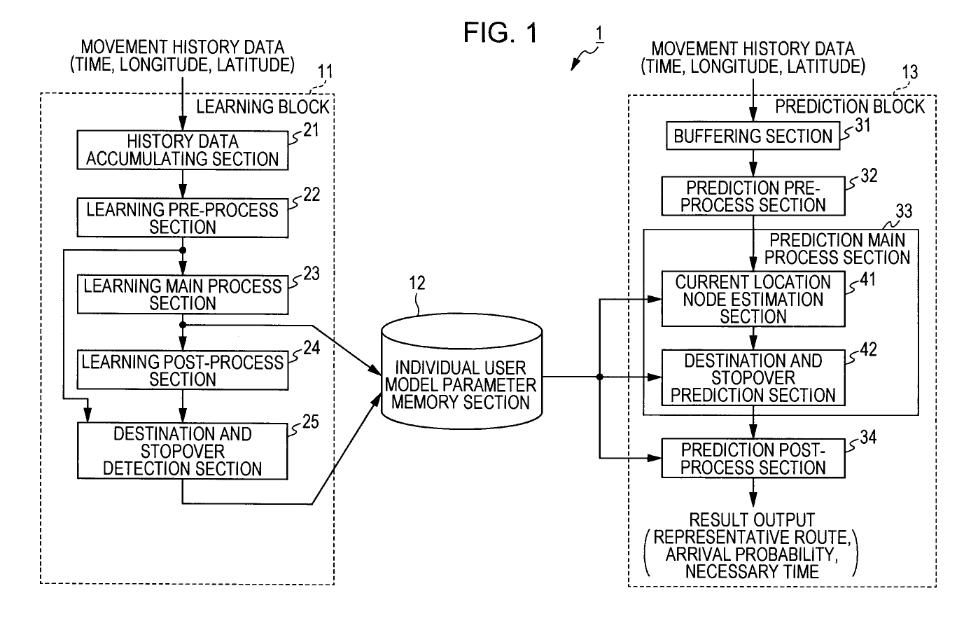

FIG. 1 shows a configuration example of a prediction system according to an embodiment of the invention.

A prediction system 1 of FIG. 1 is configured by a learning block 11, an individual user model parameter memory section 12, and a prediction block 13.

In the learning block 11, time series data is supplied which shows the position (longitude and latitude) of a user at a predetermined point in time and which is obtained for a determined time in a sensor device (not shown) such as a GPS (Global Positioning System) sensor. That is, in the learning block 11, time series data (referred to below as movement history data) is supplied which is formed three-dimensionally of position data (longitude and latitude) which is sequentially obtained at constant time intervals (for example, 15 second intervals) and the point in time at that time and which shows a movement path of a user. In addition, one unit of data of longitude, latitude, and time which configures the time series data is arbitrarily referred to as three-dimensional data.

The learning block 11 performs learning processing where a user activity model (state model which expresses behavior/activity patterns of a user) is learnt as a stochastic state transition model using user movement history data.

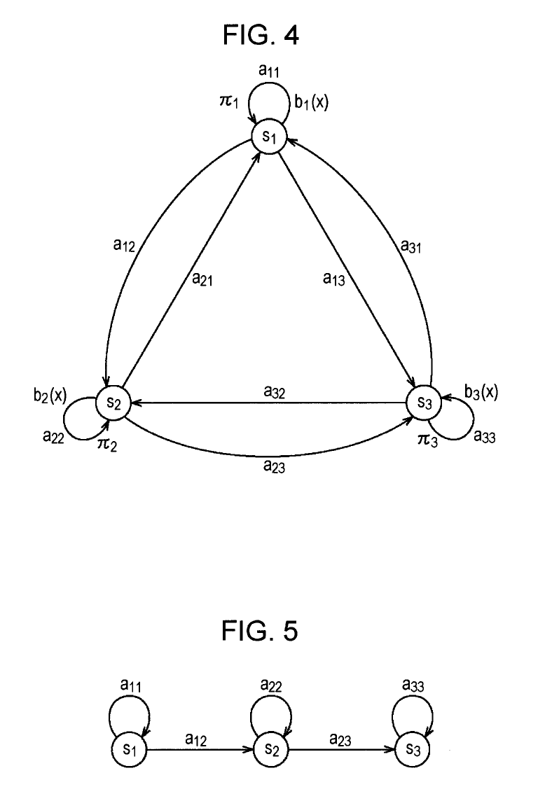

As the stochastic state transition model which is used in learning, for example, it is possible to adopt a probability model which includes hidden states such as an ergodic HMM (Hidden Markov Model). In the prediction system 1, an ergodic HMM where a sparse limitation has been applied is adopted as the stochastic state transition model. Here, a calculation method and the like of the ergodic HMM where the sparse limitation has been applied and parameters of the ergodic HMM will be described later with reference to FIGS. 4 to 6B.

The individual user model parameter memory section 12 stores parameters which are obtained by learning in the learning block 11 and expresses a user activity model.

The prediction block 13 obtains the parameters of the user activity model obtained by the learning of the learning block 11 from the individual user model parameter memory section 12. Then, the prediction block 13 estimates the current location of a user and predicts a destination which is a further movement point from the current location using the user activity model which uses the parameters obtained by learning with regard to the user movement history data which is newly obtained. Furthermore, the prediction block 13 also calculates an arrival probability, a route, and an arrival time (necessary time) to a predicted destination. Here, the destination is not limited to only one and a plurality of destinations may be predicted.

The details of the learning block 11 and the prediction block 13 will be described.

The learning block 11 is configured by a history data accumulating section 21, a learning pre-process section 22, a learning main process section 23, a learning post-process section 24, and a destination and stopover detection section 25.

The history data accumulating section 21 accumulates (stores) the user movement history data supplied from a sensor device as learning data. The history data accumulating section 21 supplies the movement history data to the learning pre-process section 22 when necessary.

The learning pre-process section 22 resolves problems which occur in the sensor device. Specifically, the learning pre-process section 22 molds the movement history data and supplements by performing an interpolation process and the like on temporarily missing data. In addition, the learning pre-process section 22 applies a movement attribute of either a “stationary state” of being stationary (stopping) in one location or a “movement state” of movement with regard to each unit of the three-dimensional data which configures the movement history data. The movement history data after applying the movement attribute is supplied to the learning main process section 23 and the destination and stopover detection section 25.

The learning main process section 23 models the user activity model as a stochastic state transition model. That is, the learning main process section 23 determines parameters when the user movement history is modeled as a stochastic state transition model. The parameters of the user activity model obtained by learning are supplied to the learning post-process section 24 and the individual user model parameter memory section 12.

The learning post-process section 24 converts each unit of the three-dimensional data which configures the movement history data to state nodes of the user activity model using the user activity model obtained by the learning of the learning main process section 23. That is, the learning post-process section 24 generates times series data of the state nodes of the user activity model which correspond to the movement history data (state node series data). At this time, the learning post-process section 24 performs partial correction of the state node series data by adding a bias which is based on common knowledge. The learning post-process section 24 supplies the state node series data after conversion and correction to the destination and stopover detection section 25.

The destination and stopover detection section 25 attaches a link between the movement history data after applying of the movement attribute, which is supplied from the learning pre-process section 22, and the state node series data, which is supplied from the learning post-process section 24. That is, the destination and stopover detection section 25 allocates the respective units of the three-dimensional data which configures the movement history data to the state nodes of the user activity model.

Then, the destination and stopover detection section 25 applies a destination or a stopover attribute to the state nodes which correspond to the three-dimensional data where the movement attribute is “stationary state” from each of the state nodes of the state node series data. According to this, (the state node which corresponds to) a predetermined location in the user movement history is allocated as a destination or a stopover. Using the destination and stopover detection section 25, information on the attribute of a destination or a stopover applied to the state nodes is supplied to the individual user model parameter memory section 12 and stored.

The prediction block 13 is configured by a buffering section 31, a prediction pre-process section 32, a prediction main process section 33, and a prediction post-process section 34.

The buffering section 31 buffers (stores) movement history data obtained in real time for prediction processing. Here, as the movement history data for prediction processing, data for a shorter period than the movement history data at the time of learning processing, for example, movement history data of approximately 100 steps, is sufficient. The buffering section 31 typically stores a predetermined time amount of the latest movement history data and deletes the oldest data from the stored data when new data is obtained.

The prediction pre-process section 32 resolves problems which occur in the sensor device in the same manner as the learning pre-process section 22. That is, the prediction pre-process section 32 molds the movement history data and supplements by performing an interpolation process and the like on temporarily missing data.

The prediction main process section 33 is configured by a current location node estimation section 41 and a destination and stopover prediction section 42. In the prediction main process section 33, the parameters are supplied, which express the user activity model and which are obtained by the learning of the learning block 11, from the individual user model parameter memory section 12.

The current location node estimation section 41 estimates the state node which corresponds to the current location of a user (current location node) using the movement history data supplied from the prediction pre-process section 32 and the user activity model obtained by the learning of the learning block 11. In the estimation of the state node, it is possible to adopt Viterbi maximum likelihood estimation or soft-decision Viterbi estimation.

The destination and stopover prediction section 42 calculates a node series to a destination state node (destination node) and an occurrence probability thereof in a tree structure formed by a plurality of state nodes for which it is possible to transition to from the current location node estimated by the current location node estimation section 41. Here, since there are cases where a stopover node is included in the node series (route) to the destination state node, the destination and stopover prediction section 42 also predicts the stopovers at the same time as the destinations.

The prediction post-process section 34 determines the total of the selection probabilities (occurrence probabilities) of the plurality of routes to the one destination as an arrival probability. In addition, the prediction post-process section 34 selects one or more of the routes from the routes to the destination as a representative (referred to below as representative route) and calculates the necessary time of the representative route. Then, the prediction post-process section 34 outputs the representative route, the arrival probability, and the necessary time to the predicted destination as a prediction result. Here, frequency instead of the occurrence probability of the route and arrival frequency instead of the arrival probability to the destination may be output as the prediction result.

Hardware Configuration Example of Prediction System

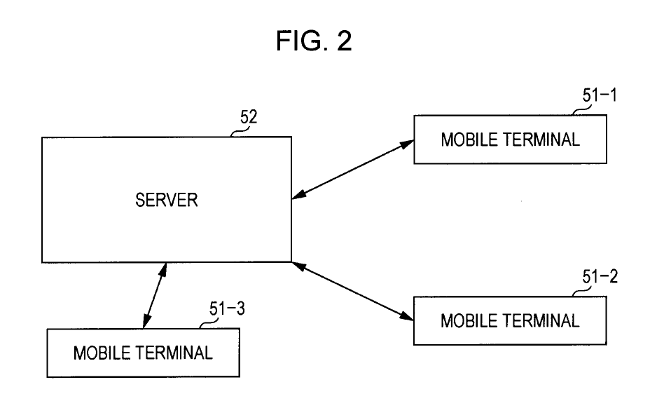

It is possible for the prediction system 1 which is configured as above to adopt, for example, the hardware configuration shown in FIG. 2. That is, FIG. 2 is a block diagram illustrating a hardware configuration example of the prediction system 1.

In FIG. 2, the prediction system 1 is configured by three mobile terminals 51-1 to 51-3 and a server 52. The mobile terminals 51-1 to 51-3 are the same mobile terminals 51 with the same functions, but the mobile terminals 51-1 to 51-3 are held by different users. Accordingly, in FIG. 2, only the three mobile terminals 51-1 to 51-3 are shown, but there is actually a number of mobile terminals 51 which depends on the number of users.

It is possible for the mobile terminal 51 to perform transfer of data with the server 52 using wireless communication or communication via a network such as the internet. The server 52 received data sent from the mobile terminal 51 and performs predetermined processing with regard to the received data. Then, the server 52 sends the processing result of the data processing to the mobile terminal 51 using wireless communication or the like.

Accordingly, the mobile terminal 51 and the server 52 have at least a communication section which performs wireless or wired communication.

Furthermore, it is possible to adopt a configuration where the mobile terminal 51 is provided with the prediction block 13 of FIG. 1 and the server 52 is provided with the learning block 11 and the individual user model parameter memory section 12 of FIG. 1.

In the case of adopting the configuration, for example, in the learning processing, the movement history data obtained using the sensor device of the mobile terminal 51 is sent to the server 52. The server 52 learns and stores the user activity model based on the received movement history data for learning. Then, in the prediction processing, the mobile terminal 51 obtains the parameters of the user activity model obtained by learning, estimates the current location node of a user from the movement history data obtained in real time, and further calculates the destination node and the arrival probability, the representative route and the necessary time to the destination node. Then, the mobile terminal 51 displays the prediction result on a display section (not shown) such as a liquid crystal display.

It is possible to arbitrarily determine the allocation of functions between the mobile terminal 51 and the server 52 such as the above according to the respective processing capabilities as data processing devices and the communication environment.

The time necessary for each one processing in the learning processing is considerably long but it is not necessary to frequently perform processing. Accordingly, since the server 52 typically has higher processing capabilities than the mobile terminal 51 which is able to be carried, it is possible to make the server 52 perform the learning processing (updating of the parameters) approximately once a day based on the accumulated movement history data.

On the other hand, since it is desirable that the prediction processing is processed and displayed promptly in correspondence with the movement history data updated in real time at each point in time, it is desirable that the processing is performed in the mobile terminal 51. If the communication environment is excellent, having the server 52 also perform the prediction processing and receiving only the prediction result from the server 52 reduces the burden on the mobile terminal 51, for which a reduction in size so as to be able to be carried is demanded, and is desirable.

In addition, in a case where it is possible to perform the learning processing and the prediction processing at a high speed using only the mobile terminal 51 as the data processing device, it is of course possible to provide all of the configuration of the prediction system 1 of FIG. 1 in the mobile terminal 51.

Example of Input Movement History Data

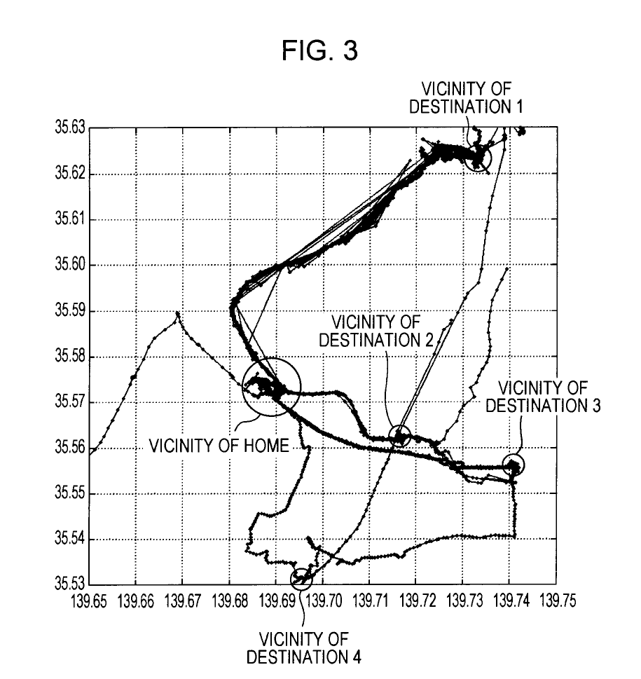

FIG. 3 shows an example of the movement history data obtained by the prediction system 1. In FIG. 3, the horizontal axis represents longitude and the vertical axis represents latitude.

The movement history data shown in FIG. 3 shows the movement history data accumulate in a period of approximately one and a half months by an experimenter. As shown in FIG. 3, the movement history data is data of movement mainly in the vicinity of home and to four other destinations such as to work. Here, the movement history data is not able to be captured by satellites and data where there are jumps in locations are also included.

Ergodic HMM

Next, an ergodic HMM which the prediction system 1 adopts as a learning model will be described.

FIG. 4 shows an example of an HMM.

HMM is a state transition model which has state nodes and transition between states nodes.

FIG. 4 shows an example of an HMM of three states.

In FIG. 4 (in the same manner as the following diagrams), a circle represents a state node and an arrow represents state node transition. In addition, below, the state node may be simply referred to as a node or a state.

In addition, in FIG. 4, sᵢ (in FIG. 4, i=1, 2, 3) represents a state and aᵢⱼ represents a state transition probability from a state sᵢ to a state sⱼ. Furthermore, bⱼ(x) represents an output probability density function where an observation value x is observed during state transition to a state sⱼ and πᵢ represents an initial probability that a state sᵢ is an initial state.

Here, as the output probability density function bⱼ(x), for example, a normal probability distribution or the like may be used.

Here, the HMM (continuous HMM) is defined by the state transition probability aᵢⱼ, the output probability density function bⱼ(x), and the initial probability πᵢ. The state transition probability aᵢⱼ, the output probability density function bⱼ(x), and the initial probability πᵢ are parameters of the HMM λ={aᵢⱼ, bⱼ(x), πᵢ, i=1, 2, . . . , M, j=1, 2, . . . , M}. M represents the number of states of the HMM.

As a method of estimating the parameters λ of the HMM, a Baum-Welch maximum likelihood estimation method is widely used. The Baum-Welch maximum likelihood estimation method is a parameter estimation method based on an EM (Expectation-Maximization) algorithm.

According to the Baum-Welch maximum likelihood estimation method, estimation of the parameters λ of the HMM is performed so that the likelihood determined from the occurrence probabilities, which are probabilities which are observed (occur) in the time series data, are maximized based on the observed time series data x=x₁, x₂, . . . , x_{T}. Here, xₜ represents a signal (sample value) observed at a point in time t and T represents the length (number of samples) of the time series data.

The Baum-Welch maximum likelihood estimation method is described in, for example, in p. 333 of “Pattern Recognition and Machine Learning (Information Science and Statistics)”, Christopher M. Bishop, Springer, New York, 2006.

Here, the Baum-Welch maximum likelihood estimation method is a parameter estimation method based on likelihood maximization, but there is no guarantee of optimality and depending on the configuration of the HMM and the initial values of the parameters λ, there may be convergence to a local minima.

The HMM is widely used in sound recognition, but in the HMM used in sound recognition, the number of states, the method of state transition, and the like are typically determined in advance.

FIG. 5 shows an example of an HMM used in sound recognition.

The HMM of FIG. 5 is referred to as a left-to-right type.

In FIG. 5, the number of states is three and state transition is limited to a configuration which allows only self transition (state transition from the state sᵢ to the state sᵢ) and state transition from a left state to a right state.

With regard to the HMM where there is a limitation on state transition as in the HMM of FIG. 5, the HMM shown in FIG. 4 where there is no limitation in state transition, that is, the HMM where state transition from an arbitrary state sᵢ to an arbitrary state sⱼ is possible, is referred to as an ergodic HMM.

The ergodic HMM is an HMM which has the highest degree of freedom in terms of structure, but it becomes difficult to estimate the parameters λ as the number of states increases.

For example, in a case where the number of states of an ergodic HMM is 1000, the number of state transitions becomes 1000000 (=1000×1000).

Accordingly, in this case, out of the parameters λ, for example, with regard to the state transition probability aᵢⱼ, it is necessary to estimate 1000000 of the state transition probabilities aᵢⱼ.

Therefore, in state transition set with regard to the states, it is possible to apply, for example, a limitation (sparse limitation) which is a sparse configuration.

Here, the sparse limitation is a configuration where the states for which it is possible to perform state transition from a certain state is significantly limited and is not dense state transition such as with the ergodic HMM where state transition from an arbitrary state to an arbitrary state is possible. Here, even with the sparse configuration, there is at least one state transition to another state, and also, there is self transition.

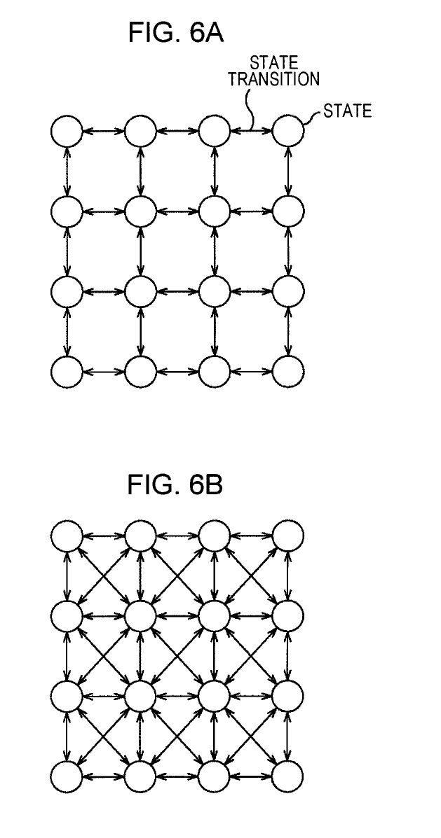

FIGS. 6A and 6B show an example of an HMM where a sparse limitation is applied.

Here, in FIGS. 6A and 6B, arrows in both directions connecting two states represent state transition from one state out of the two states to the other state and state transition from the other state to the one state. In addition, in FIGS. 6A and 6B, each state transition, self transition is possible for each state and the diagrammatical representation of the arrows which represent self transition are omitted.

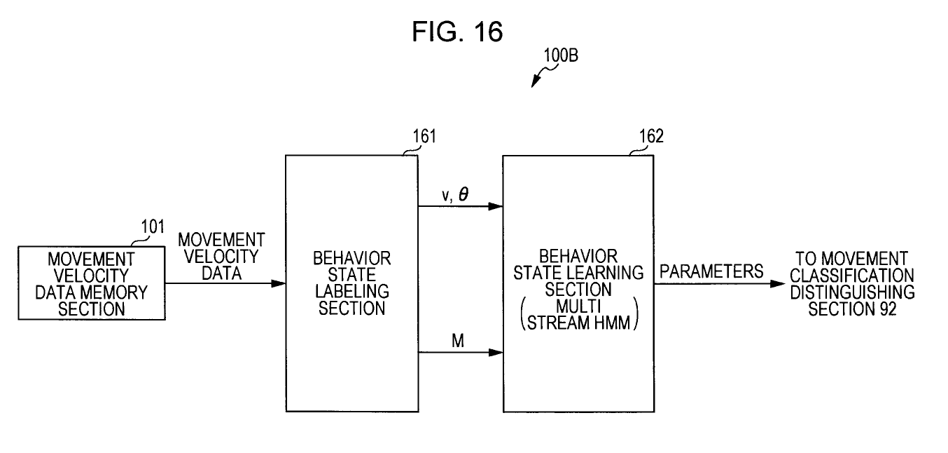

In FIGS. 6A and 6B, 16 states are arranged in a grid formation in a two-dimensional space. That is, in FIGS. 6A and 6B, four states are arranged in the horizontal direction and four states are arranged also in the vertical direction.

Here, when the distance between states which are adjacent in the horizontal direction and the distance between states which are adjacent in the vertical direction are both set as one, FIG. 6A shows a HMM where a sparse limitation has been applied where state transition is possible to states where the distance is one or less and state transition to other states is not possible.

In addition, FIG. 6B shows a HMM where a sparse limitation has been applied where state transition is possible to states where the distance is √2 or less and state transition to other states is not possible.

In the example of FIG. 1, the prediction system 1 supplies the movement history data x=x₁, x₂, . . . , x_{T}, the learning block 11 uses the movement history data x=x₁, x₂, . . . , x_{T} and estimates the parameters λ of the HMM which represent the user activity model.

That is, data on the positions (longitude and latitude) at each point in time which represent a movement trajectory of a user are considered to be observation data of stochastic variables which are normally distributed with a spread of a predetermined variance from a point on a map which corresponds to any one of the states sⱼ of the HMM. The learning block 11 optimizes the point on the map which corresponds to each of the states sⱼ (average μⱼ), the variance σᵢ², and the state transition probability aᵢⱼ.

Here, it is possible to set the initial probability πᵢ of the state sᵢ to a uniform value. For example, the initial probabilities πᵢ of each of the M states sᵢ may be set to 1/M.

With regard to the user activity model (HMM) obtained by learning, the current location node estimation section 41 applies a Viterbi algorithm and determines a state transition path (series of states) (referred to below as maximum likelihood path) which maximizes the likelihood that the movement history data x=x₁, x₂, . . . , x_{T} is observed. According to this, the state sᵢ which corresponds to the current location of a user is recognized.

Here, the Viterbi algorithm is an algorithm which determines a path (maximum likelihood path) which maximizes the cumulative value (occurrence probability) of the state transition probability aᵢⱼ of a state transition from a state sᵢ to a state sⱼ at a point in time t and the probability that the sample value xₜ is observed at the point in time t out of the movement history data x=x₁, x₂, . . . , x_{T} in the state transition (the output probability determined from the output probability density function bⱼ(x)) over the length T of the time series data x after processing in a state transition path with a start point at each of the states sᵢ. The details of the Viterbi algorithm are described in P. 347 of “Pattern Recognition and Machine Learning (Information Science and Statistics)”, Christopher M. Bishop, Springer, New York, 2006, described above.

Configuration Example of Learning Pre-Process Section 22

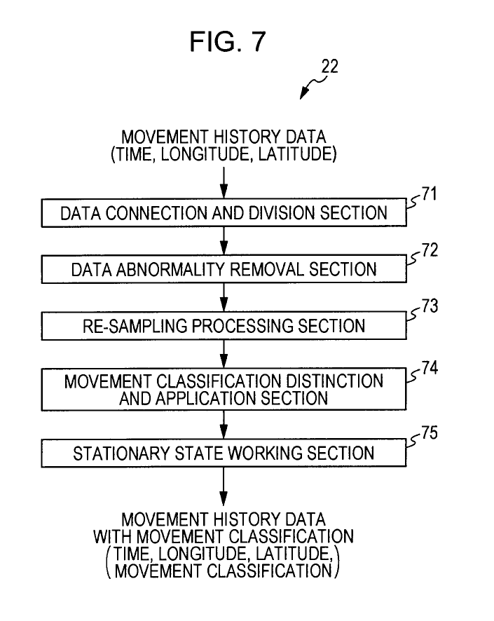

FIG. 7 is a block diagram illustrating a detailed configuration example of the learning pre-process section 22 of the learning block 11.

The learning pre-process section 22 is configured by a data connection and division section 71, a data abnormality removal section 72, a re-sampling processing section 73, a movement attribute distinction and application section 74, and a stationary state working section 75.

The data connection and division section 71 performs processing of the connection and division of the movement history data. In the data connection and division section 71, the movement history data is supplied from the sensor device as a log file in predetermined units such as a unit of one day. Accordingly, the movement history data which is normally continuous during movement to a certain destination is divided up as it spans over dates and is obtained. The data connection and division section 71 connects the movement history data divided up in this manner. Specifically, if a time difference of the last three-dimensional data (longitude, latitude, and time) in one log file and the first three-dimensional data in a log file created next after the one log file is within a predetermined time, the data connection and division section 71 connects the movement history data in the files.

In addition, for example, since a GPS sensor is not able to capture a satellite in a tunnel or underground, the interval between when the movement history data is obtained may become longer. In a case where the movement history data is missing for a long time, it is difficult to estimate where the user has gone. Therefore, in a case where the interval before and after the obtaining time of the obtained movement history data is equal to or more than a predetermined time interval (referred to below as missing threshold time), the data connection and division section 71 divides the movement history data before and after the interval. Here, the missing threshold time is 5 minutes, 10 minutes, 1 hour, or the like.

The data abnormality removal section 72 performs processing which removes obvious abnormalities from the movement history data. For example, in a case where there is a jump and position data at a certain point in time is separated from the previous and next positions by 100 m or more, the position data is an abnormality. Therefore, in a case where position data at a certain point in time is separated from both the previous and next positions by a predetermined distance or more, the data abnormality removal section 72 removes the three-dimensional data from the movement history data.

The re-sampling processing section 73 performs processing which supplements missing data where the time interval of the obtaining time is less than the missing threshold time using linear interpolation or the like. That is, in a case where the time interval of the obtaining time is equal to or more than the missing threshold time, the movement history data is divided up using the data connection and division section 71, but there is still the missing data which is less than the missing threshold time. Therefore, the re-sampling processing section 73 supplements the missing data where the time interval of the obtaining time is less than the missing threshold time.

The movement attribute distinction and application section 74 distinguishes and applies the movement attribute to each unit of the three-dimensional movement history data as either a “stationary state” of being stationary (stopping) in one location or a “movement state” of movement. According to this, the movement history data with the movement attribute is generated where the movement attribute is applied to the respective units of the three-dimensional movement history data.

The stationary state working section 75 works three-dimensional data with a “stationary state” movement attribute based on the movement history data with the movement attribute supplied from the movement attribute distinction and application section 74. More specifically, in a case where the “stationary state” movement attribute continues for a predetermined time or more (referred to below as stationary threshold time), the stationary state working section 75 divides up the movement history data before and after. In addition, in a case where the “stationary state” movement attribute continues for less than the stationary threshold time, the stationary state working section 75 holds the position data of the plurality of three-dimensional “stationary state” data continuously over the predetermined time within the stationary threshold time (corrects to position data at one location). According to this, it is possible to prevent a plurality of “stationary state” nodes being allocated with regard to the movement history data of the same destination or stopover. In other words, it is possible to prevent the same destination or stopover being expressed as a plurality of nodes.

Processing of Learning Pre-Process Section 22

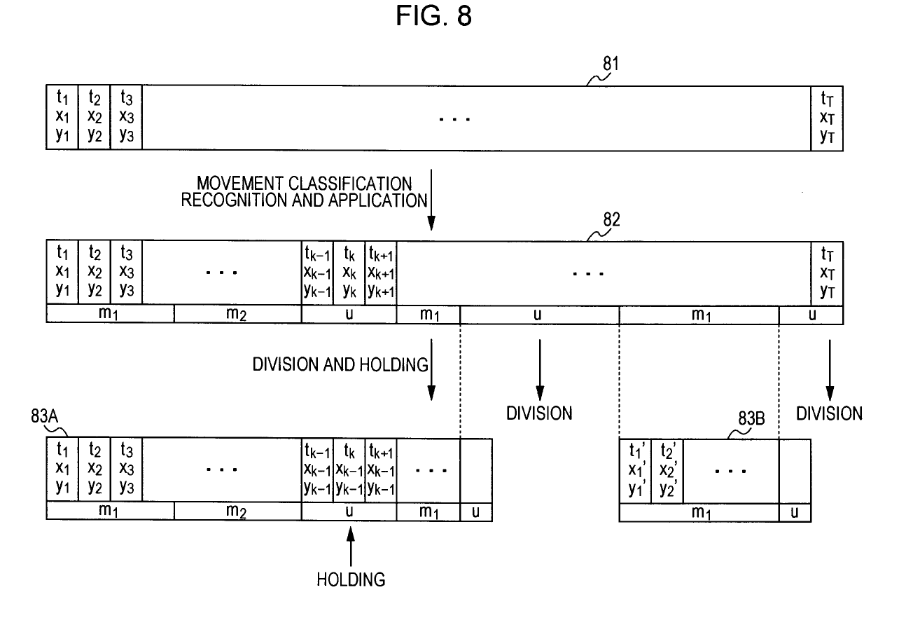

FIG. 8 is an image diagram conceptually illustrating learning pre-process processing of the learning pre-process section 22.

The movement attribute distinction and application section 74 distinguishes and applies the movement attribute of either the “stationary state” or the “movement state” with regard to movement history data 81 after the data supplementing by re-sampling processing section 73 shown in the upper level of FIG. 8. As a result, movement history data 82 with the movement attribute shown in the middle level of FIG. 8 is generated.

In the movement history data 82 with the movement attribute in the middle level of FIG. 8, “m₁” and “m₂” represent the “movement state” movement attributes and “u” represents the “stationary state” movement attribute. Here, even if “m₁” and “m₂” are the same “movement state”, the movement means (car, bus, train, walking, or the like) is different.

Then, processing of the division or the holding of the movement history data is executed by the stationary state working section 75 with regard to the movement history data 82 with the movement attribute in the middle level of FIG. 8, and movement history data 83 (83A and 83B) with the movement attribute shown in the lower level of FIG. 8 is generated.

In the movement history data 83 with the movement attribute, division processing is performed at a “movement state” location (three-dimensional data) generated second in the movement history data 82 with the movement attribute, and the movement history data 83A and 83B with the movement attribute are divided up.

In the division processing, initially, the plurality of three-dimensional data is divided between the “movement state” which occurs second in the movement history data 82 with the movement attribute and the remaining three-dimensional data, and there are two movement history data 83A and 83B with the movement attribute. Next, from the movement history data 83A and 83B with the movement attribute which have been divided, the last of the three-dimensional data on the plurality of “movement states”, which are equal to or longer than the stationary threshold value, of the movement history data 83A with the movement attribute, which is earlier in terms of time, are grouped as the three-dimensional data on one “stationary state”. According to this, it is possible to shorten the learning time since unnecessary movement history data is removed.

In addition, in FIG. 8, the three-dimensional data on the “plurality of movement states” which occur third in the movement history data 82 with the movement attribute is also data where the “movement states” which are equal to or longer than the stationary threshold value time continue, and the same manner of division processing is performed. However, since there is no later three-dimensional data after the division, the three-dimensional data on the plurality of “movement states” which are equal to or longer than the stationary threshold value time is only grouped as the three-dimensional data on one “stationary state”.

On the other hand, in the movement history data of the first “movement state” from the movement history data 83A with the movement attribute, hold processing is executed. After the hold processing, the three-dimensional data on three “movement states” {(tₖ₋₁, xₖ₋₁, yₖ₋₁), (tₖ, xₖ, yₖ), (tₖ₊₁, xₖ₊₁, yₖ₊₁)} becomes {(tₖ₋₁, xₖ₋₁, yₖ₋₁), (tₖ, xₖ₋₁, yₖ₋₁), (tₖ₊₁, xₖ₋₁, yₖ₋₁)}. That is, the position data is corrected to the position data of the initial “movement state”. Here, in the hold processing, the position data may be updated to the position data of an average value position, an intermediate point in time in the time of the “movement state” instead of being updated to the position data of the initial “movement state”, or the like.

Configuration Example of Movement Attribute Distinction and Application Section 74

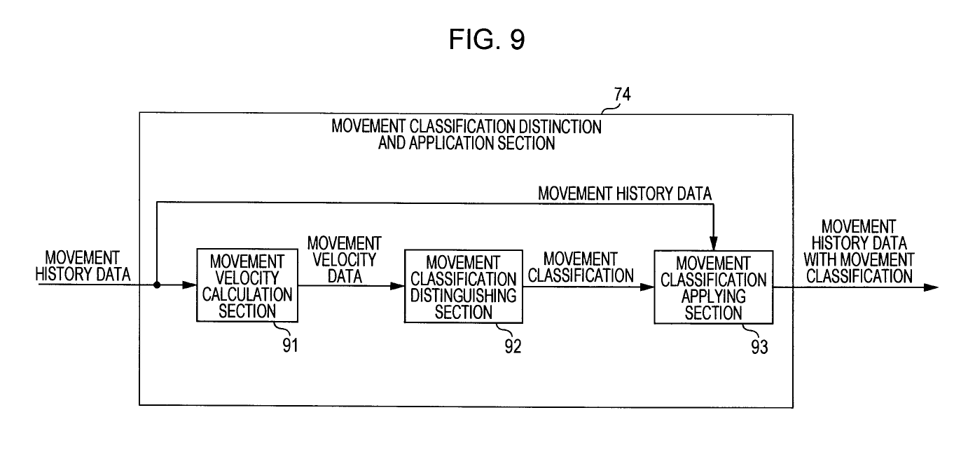

FIG. 9 is a block diagram illustrating a detailed configuration example of the movement attribute distinction and application section 74.

The movement attribute distinction and application section 74 is configured by a movement velocity calculation section 91, a movement attribute distinguishing section 92, and a movement attribute applying section 93.

The movement velocity calculation section 91 calculates the movement velocity from the supplied movement history data.

Specifically, when the three-dimensional data when obtained in a k^{th} step at a constant time interval is represented as a time tₖ, a longitude yₖ, and a latitude xₖ, it is possible to calculate movement velocity vxₖ in an x direction and movement velocity vyₖ in a y direction of the k^{th} step using equation (1).

$${vx}_{k} = \frac{{x}_{k} - {x}_{k - 1}}{{t}_{k} - {t}_{k - 1}} \\ {vy}_{k} = \frac{{y}_{k} - {y}_{k - 1}}{{t}_{k} - {t}_{k - 1}} \qquad ( 1 )$$

In equation (1), the longitude and latitude data is used as it is, but it is possible to appropriately perform processing as necessary where the longitudes and latitudes are converted to distances, the velocity is converted so as to be represented by distance per hour or distance per minute, or the like.

In addition, from the movement velocity vxₖ and the movement velocity vyₖ obtained from equation (1), the movement velocity calculation section 91 further determines a movement velocity vₖ and a travelling direction change θₖ of the k^{th} step represented by equation (2) and it is possible to use the movement velocity vₖ and the travelling direction change θₖ.

$${v}_{k} = \sqrt{{vx}_{k}^{2} + {vy}_{k}^{2}} \\ {θ}_{k} = {sin}^{- 1} ( \frac{{vx}_{k} \cdot {vy}_{k - 1} - {vx}_{k - 1} \cdot {vy}_{k}}{{v}_{k} \cdot {v}_{k - 1}} ) \qquad ( 2 )$$

By using the movement velocity vₖ and the travelling direction change θₖ represented by equation (2), it is possible to draw out characteristics with regard to the points below compared to the movement velocity vxₖ and the movement velocity vyₖ of equation (1).

1. Since there is bias in the distribution of the data of the movement velocities vxₖ and vyₖ with regard to the longitudinal and latitudinal axes, there is a possibility that it is not possible to distinguish in a case where angles are different even with the same movement means (train, walking, and the like), but the possibility is low with the movement velocity vₖ.

2. When learning using only an absolute size of the movement velocity (|v|), it is not possible to distinguish walking and being stationary because of |v| which results from device noise. By also considering the change in travelling direction, it is possible to reduce the effect of noise.

3. There is little change in the travelling direction in the case of movement, but since the travelling direction is not set in the case of being stationary, it is easy to distinguish between movement and being stationary when the change in travelling direction is used.

From the reasons above, in the embodiment, the movement velocity calculation section 91 determines the movement velocity vₖ and the travelling direction change θₖ represented by equation (2) as the movement velocity data and supplies the data to the movement attribute distinguishing section 92.

Before performing the calculation of the movement velocity vₖ and the travelling direction change θₖ, since the movement velocity calculation section 91 removes noise components, it is possible to perform filtering processing (pre-processing) using a moving average.

Here, in the sensor device, there are devices which are able to output movement velocity. In a case of adopting the sensor device such as this, the movement velocity calculation section 91 is omitted and it is possible to use the movement velocity output by the sensor device as it is. Below, the travelling direction change θₖ is abbreviated to the travelling direction θₖ.

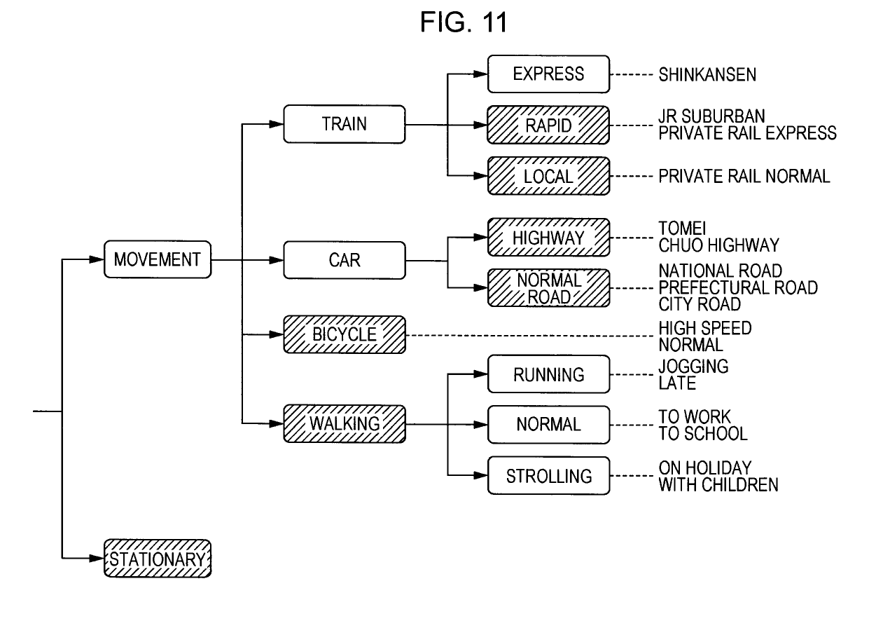

The movement attribute distinguishing section 92 distinguishes the movement attribute based on the supplied movement velocity and supplies the recognition result to the movement attribute applying section 93. More specifically, the movement attribute distinguishing section 92 learns the user behavior state (movement state) as the stochastic state transition model (HMM) and distinguishes the movement attribute using the stochastic state transition model obtained by learning. As the movement attributes, it is necessary that there is at least the “stationary state” and the “movement state”. In the embodiment, as will be described later with reference to FIG. 11 and the like, the movement attribute distinguishing section 92 outputs the movement attribute where the “movement state” has been further classified by a plurality of movement means such as walking, bicycle, or car.

The movement attribute applying section 93 applies the movement attribute recognized by the movement attribute distinguishing section 92 to each unit of the three-dimensional data from the re-sampling processing section 73 which configures the movement history data, and the movement history data with the movement attribute is generated and output to the stationary state working section 75.

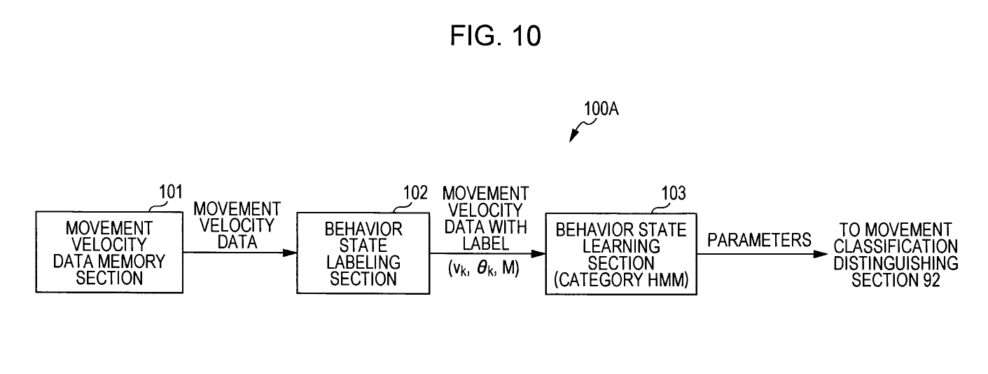

Next, the determining of the parameters of the stochastic state transition model which represents the user behavior state and is used in the movement attribute distinguishing section 92 will be described with reference to FIGS. 10 to 17.

First Configuration Example of Learning Unit of Movement Attribute Distinguishing Section 92

FIG. 10 shows a configuration example of a learning unit 100A which learns the parameters of the stochastic state transition model used in the movement attribute distinguishing section 92 using a category HMM.

In the category HMM, that the teaching data which learns is data which belongs to which category (class) is already known in advance and the parameters of the HMM are learnt for each category.

The learning unit 100A is configured by a movement velocity data memory section 101, a behavior state labeling section 102, and a behavior state learning section 103.

The movement velocity data memory section 101 stores time series data on the movement velocity as learning data.

The behavior state labeling section 102 applies a user behavior state as a label (category) with regard to movement velocity data which is sequentially supplied in a time series from the movement velocity data memory section 101. The behavior state labeling section 102 supplies the movement velocity data with a label, where the behavior state is correspondingly attached to the movement velocity data, to the behavior state learning section 103. For example, with regard to the movement velocity vₖ and the travelling direction θₖ of the k^{th} step, data attached with the label M which represents the behavior state is supplied to the behavior state learning section 103.

The behavior state learning section 103 classifies the movement velocity data with a label which is supplied from the behavior state labeling section 102 into each category and learns the parameters of the user activity model (HMM) in category units. The parameters for each category obtained from the learning result are supplied to the movement attribute distinguishing section 92.

Attribute Example of Behavior State

FIG. 11 shows an attribute example in a case where behavior states are classified into each category.

As shown in FIG. 11, first, it is possible for the user behavior state to be classified into the stationary state and the movement state. In the embodiment, as the user behavior state which is recognized by the movement attribute distinguishing section 92, as described above, since it is necessary that there is at least the stationary state and the movement state, it is necessary that there is attribute into the stationary state and the movement state.

Furthermore, it is possible to classify the movement state into train, car (including bus and the like), bicycle, or walking depending on the movement means. It is possible to further classify train into express, rapid, local, or the like, and it is possible to further classify car as highway, normal road, or the like. In addition, it is possible to classify walking into running, normal, strolling, or the like.

In the embodiment, the user behavior states are classified as “stationary”, “train (rapid)”, “train (local)”, “car (highway)”, “car (normal road)”, “bicycle”, and “walking” shown by diagonal lines in FIG. 11. Here, “train (express)” is omitted since the learning data was not obtained.

Here, it is needless to say that the method of classifying the categories is not limited to the example shown in FIG. 11. In addition, since the change in the movement velocity due to the movement means is not significantly different depending on a user, it is not necessary that the time series data on the movement velocity as the learning data is that of the recognition target user.

Processing Example of Behavior State Labeling Section 102

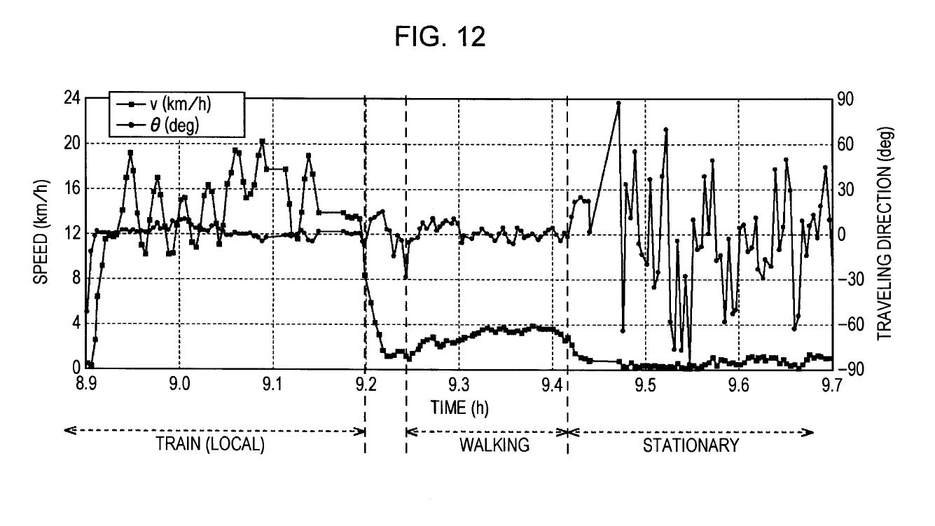

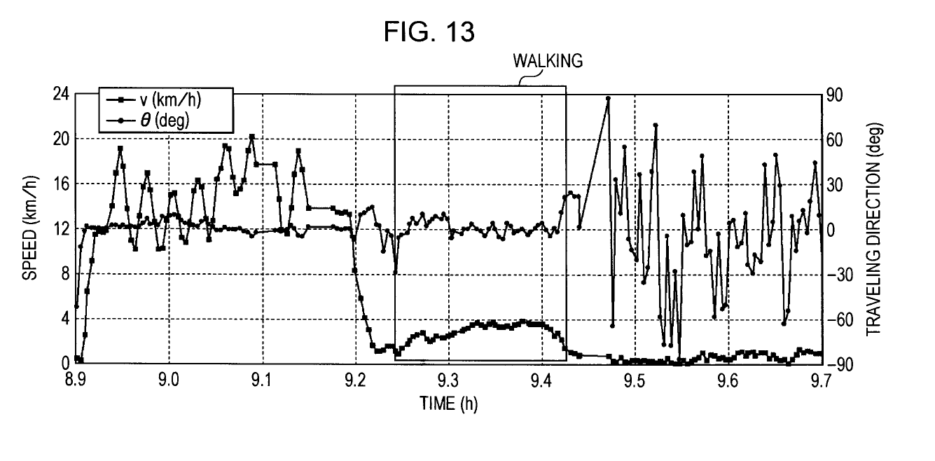

Next, a processing example of the behavior state labeling section 102 will be described with reference to FIGS. 12 and 13.

FIG. 12 shows an example of time series data on the movement velocity supplied to the behavior state labeling section 102.

In FIG. 12, the movement velocity data (v, θ) supplied from the behavior state labeling section 102 is shown in the form of (t, v) and (t, θ). In FIG. 12, square (▪) plotting represents the movement velocity v and circle () plotting represents the travelling direction θ. In addition, the horizontal axis represents time t, the vertical axis on the right side represents travelling direction θ, and the vertical axis on the left side represents the movement velocity v.

The words “train (local)”, “walking”, and “stationary” shown below the time axis in FIG. 12 have been added for description. The initial time series data of FIG. 12 is the movement velocity data in a case where a user is moving by “train (local)”, next is the movement velocity data in a case where a user is moving by “walking”, and after that is the movement velocity data in a case where a user is “stationary”.

In the case where the user is moving by “train (local)”, since there is repetition of the train stopping at a station, accelerating when the train departs and the train decelerating again to stop at a station, there are the characteristics that the plotting of the movement velocity v is repetitive and swings up and down. Here, that the movement velocity does not become 0 even in a case where the train has stopped is because filtering processing using a moving average is performed.

In addition, the case where the user is moving by “walking” and the case where the user is “stationary” are states which are the most difficult to distinguish, but due to filtering processing using a moving average, it is possible to see that the movement velocities v are clearly different. In addition, it is possible to see the characteristics of “stationary” are that the travelling direction θ momentarily changes considerably and it is clear that it is easy to distinguish from “walking”. In this manner, due to the filter processing using a moving average and the representing of the movement of the user as the movement velocity v and the travelling direction θ, it is clear that the distinguishing of “walking” and “stationary” becomes easy.

In addition, due to the filtering processing, the portion between “train (local)” and “walking” is a portion where the point where the behavior changes is not clear.

FIG. 13 shows an example where attaching of labels is performed with regard to the time series data shown in FIG. 12.

For example, the behavior state labeling section 102 displays the movement velocity data shown in FIG. 12 on a display. Then, the user performs an operation of encompassing a portion, where labels are to be attached out of the movement velocity data displayed in the display, in a rectangular region using a mouse or the like. In addition, the user inputs a label applied with regard to the specified data from a key board or the like. The behavior state labeling section 102 performs the attaching of labels by applying the input label to the movement velocity data included in the rectangular region specified by the user.

In FIG. 13, an example is shown where the movement velocity data of a portion which is equivalent to “walking” is designated by the rectangular region. In addition, at this time, due to the filtering processing, it is possible to not include the portion, where the point where the behavior changes is not clear, in the specified region. The length of the time series data is determined from a length whereby a difference in behavior is clearly apparent in the time series data. For example, it is possible to be set to approximately 20 steps (15 seconds×20 steps=300 seconds).

Configuration Example of Behavior State Learning Section 103

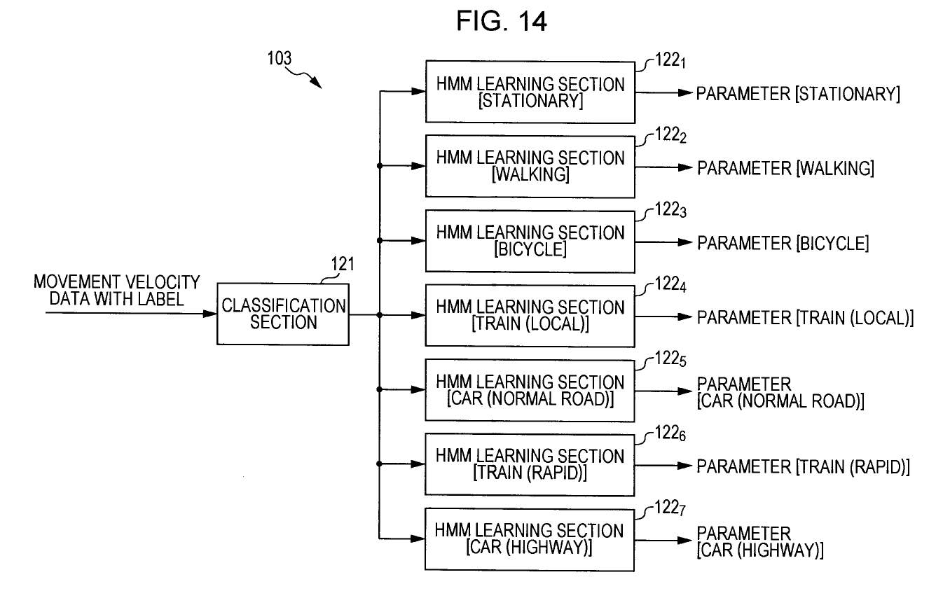

FIG. 14 is a block diagram illustrating a configuration example of the behavior state learning section 103 of FIG. 10.

The behavior state learning section 103 is configured by a classifying section 121 and HMM learning sections 122₁ to 122₇.

The label of the movement velocity data with a label supplied from the behavior state labeling section 102 is referenced by the classifying section 121 and supplied to any of the HMM learning sections 122₁ to 122₇ which correspond to a label. That is, in the behavior state learning section 103, the HMM learning sections 122 are prepared for each label (category) and the movement velocity data with a label supplied from the behavior state labeling section 102 is classified into each label and supplied.

Each of the HMM learning sections 122₁ to 122₇ learns the learning model (HMM) using the supplied movement velocity data with a label. Then, each of the HMM learning sections 122₁ to 122₇ supplies the parameters λ of the HMM obtained by learning to the movement attribute distinguishing section 92 of FIG. 9.

The HMM learning section 122₁ learns the learning model (HMM) in a case where there is a “stationary” label. The HMM learning section 122₂ learns the learning model (HMM) in a case where there is a “walking” label. The HMM learning section 122₃ learns the learning model (HMM) in a case where there is a “bicycle” label. The HMM learning section 122₄ learns the learning model (HMM) in a case where there is a “train (local)” label. The HMM learning section 122₅ learns the learning model (HMM) in a case where there is a “car (normal road)” label. The HMM learning section 122₆ learns the learning model (HMM) in a case where there is a “train (rapid)” label. The HMM learning section 122₇ learns the learning model (HMM) in a case where there is a “car (highway)” label.

First Configuration Example of Movement Attribute Distinguishing Section 92

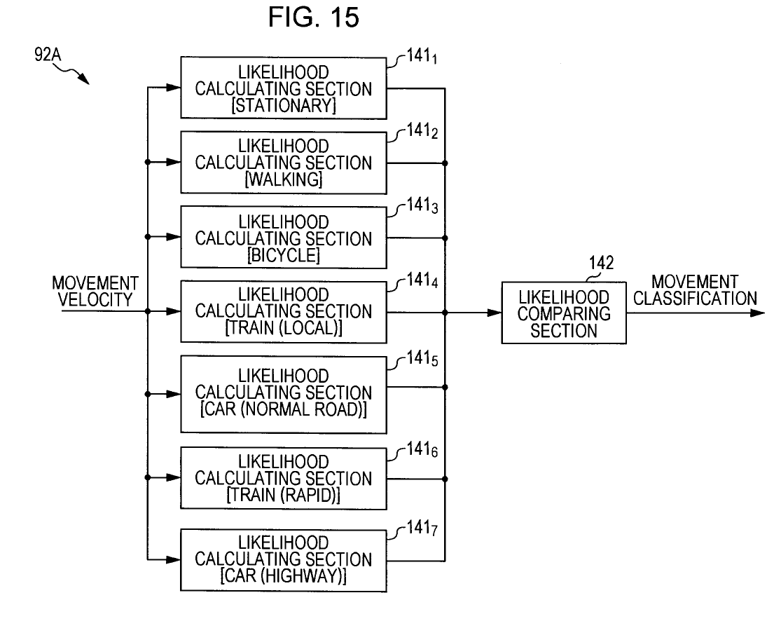

FIG. 15 is a block diagram illustrating a configuration example of a movement attribute distinguishing section 92A which is the movement attribute distinguishing section 92 in a case where the parameters learnt using the learning unit 100A.

The movement attribute distinguishing section 92A is configured by likelihood calculating sections 141₁ to 141₇ and a likelihood comparing section 142.

The likelihood calculating section 141₁ calculates a likelihood with regard to the time series data on the movement velocity supplied from the movement velocity calculation section 91 (FIG. 9) using the parameters obtained by the learning of the HMM learning section 122₁. That is, the likelihood calculating section 141₁ calculates the likelihood that the behavior state is “stationary”.

The likelihood calculating section 141₂ calculates a likelihood with regard to the time series data on the movement velocity supplied from the movement velocity calculation section 91 using the parameters obtained by the learning of the HMM learning section 122₂. That is, the likelihood calculating section 141₂ calculates the likelihood that the behavior state is “walking”.

The likelihood calculating section 141₃ calculates a likelihood with regard to the time series data on the movement velocity supplied from the movement velocity calculation section 91 using the parameters obtained by the learning of the HMM learning section 122₃. That is, the likelihood calculating section 141₃ calculates the likelihood that the behavior state is “bicycle”.

The likelihood calculating section 141₄ calculates a likelihood with regard to the time series data on the movement velocity supplied from the movement velocity calculation section 91 using the parameters obtained by the learning of the HMM learning section 122₄. That is, the likelihood calculating section 141₄ calculates the likelihood that the behavior state is “train (local)”.

The likelihood calculating section 141₅ calculates a likelihood with regard to the time series data on the movement velocity supplied from the movement velocity calculation section 91 using the parameters obtained by the learning of the HMM learning section 122₅. That is, the likelihood calculating section 141₅ calculates the likelihood that the behavior state is “car (normal road)”.

The likelihood calculating section 141₆ calculates a likelihood with regard to the time series data on the movement velocity supplied from the movement velocity calculation section 91 using the parameters obtained by the learning of the HMM learning section 122₆. That is, the likelihood calculating section 141₆ calculates the likelihood that the behavior state is “train (rapid)”.

The likelihood calculating section 141₇ calculates a likelihood with regard to the time series data on the movement velocity supplied from the movement velocity calculation section 91 using the parameters obtained by the learning of the HMM learning section 122₇. That is, the likelihood calculating section 141₇ calculates the likelihood that the behavior state is “car (highway)”.

The likelihood comparing section 142 compares the likelihoods supplied from each of the likelihood calculating sections 141₁ to 141₇, and the behavior state with the highest likelihood is selected and output as the movement attribute.

Second Configuration Example of Learning Unit of Movement Attribute Distinguishing Section 92

FIG. 16 shows a configuration example of a learning unit 100B which learns the parameters of the user activity model used in the movement attribute distinguishing section 92 using a multi stream HMM.

The learning unit 100B is configured by the movement velocity data memory section 101, a behavior state labeling section 161, and a behavior state learning section 162.

The behavior state labeling section 161 applies a user behavior state as a label (behavior mode) with regard to the movement velocity data which is sequentially supplied in a time series from the movement velocity data memory section 101. The behavior state labeling section 161 supplies the times series data (v, θ) on the movement velocity and the time series data of a behavior mode M which is correspondingly attached to the movement velocity data to the behavior state learning section 162.

The behavior state learning section 162 learns the user behavior state using the multi stream HMM.

Here, the multi stream HMM is a HMM where data which follows a plurality of different probability laws is output from state nodes which have the same transition probability as a normal HMM. In the multi stream HMM, out of the parameters λ, the output probability density function bⱼ(x) is prepared separately for each of the time series data. In the multi stream HMM, it is possible to learn while attaching correspondence between different types of the time series data (streams).

In the behavior state learning section 162, the time series data on the travelling direction θ and the movement velocity v which are continuous quantities and the time series data on the behavior mode M which is a discrete quantity are supplied. The behavior state learning section 162 learns the distribution parameters of the movement velocity output from each of the state nodes and the probability of the behavior mode. According to the multi stream HMM obtained by learning, for example, the current state node is able to be determined from the time series data on the movement velocity. Then, it is possible to recognize the behavior mode from the determined state node.

In the first configuration example using the category HMM, it is necessary that seven HMM are prepared for each category, but in the multi stream HMM, one HMM is sufficient. However, it is necessary that approximately the same number of state nodes is prepared as the total number of state nodes used in the seven categories in the first configuration example.

Second Configuration Example of Movement Attribute Distinguishing Section 92

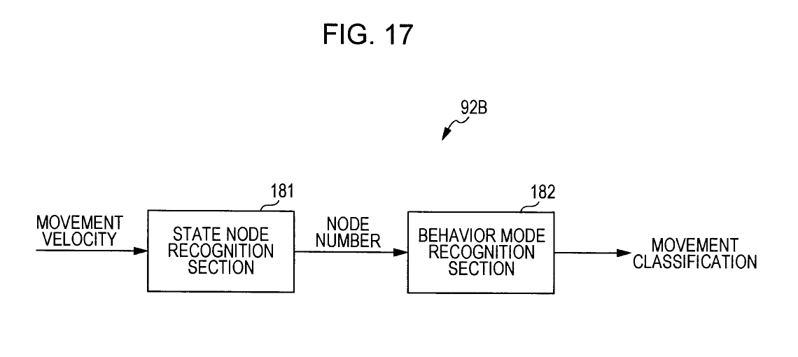

FIG. 17 is a block diagram illustrating a different configuration example of a movement attribute distinguishing section 92B which is the movement attribute distinguishing section 92 in a case where the parameters learnt by the learning unit 100B are used.

The movement attribute distinguishing section 92B is configured by a state node recognition section 181 and a behavior mode recognition section 182.

The state node recognition section 181 recognizes the state nodes of the multi stream HMM from the time series data on the movement velocity supplied from the movement velocity calculation section 91 using the parameters of the multi stream HMM learnt by the learning unit 100B. The state node recognition section 181 supplies a node number of the recognized current state node to the behavior mode recognition section 182.

The behavior mode recognition section 182 outputs the behavior mode with the highest probability as the movement attribute at the state node recognized by the state node recognition section 181.

Processing of Learning Pre-Process Section 22

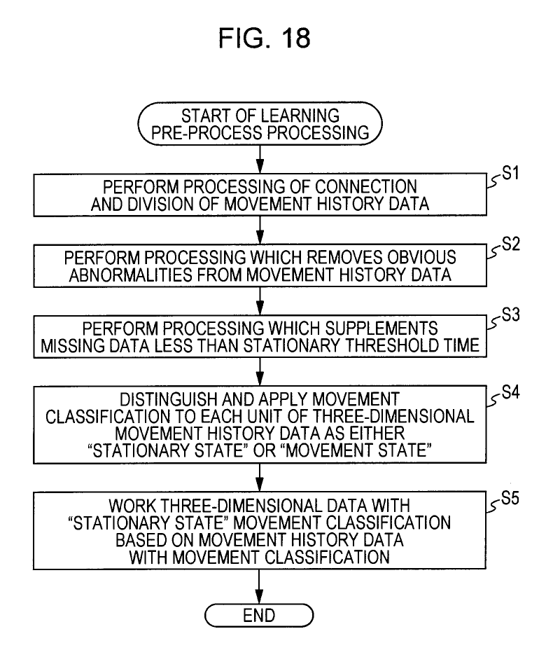

FIG. 18 is a flow chart of learning pre-process processing by the learning pre-process section 22.

In the learning pre-process processing, initially, in step S1, the data connection and division section 71 performs processing of the connection and division of the movement history data.

In step S2, the data abnormality removal section 72 performs processing which removes obvious abnormalities from the movement history data.

In step S3, the re-sampling processing section 73 performs processing which supplements missing data where the time interval of the obtaining time is less than the stationary threshold time using linear interpolation or the like.

In step S4, the movement attribute distinction and application section 74 distinguishes and applies the movement attribute to each unit of the three-dimensional movement history data as either the “stationary state” or the “movement state”.

In step S5, the stationary state working section 75 works the three-dimensional data with the “stationary state” movement attribute based on the movement history data with the movement attribute supplied from the movement attribute distinction and application section 74. Then, the stationary state working section 75 outputs the movement history data with the movement attribute after working processing to the learning main process section 23 and the processing ends.

As above, in the learning pre-process section 22, the movement history data is made into movement history data with the movement attribute, which is divided up and the like as necessary and is applied with the movement attribute, and is supplied to the learning main process section 23.

Processing of Learning Main Process Section 23

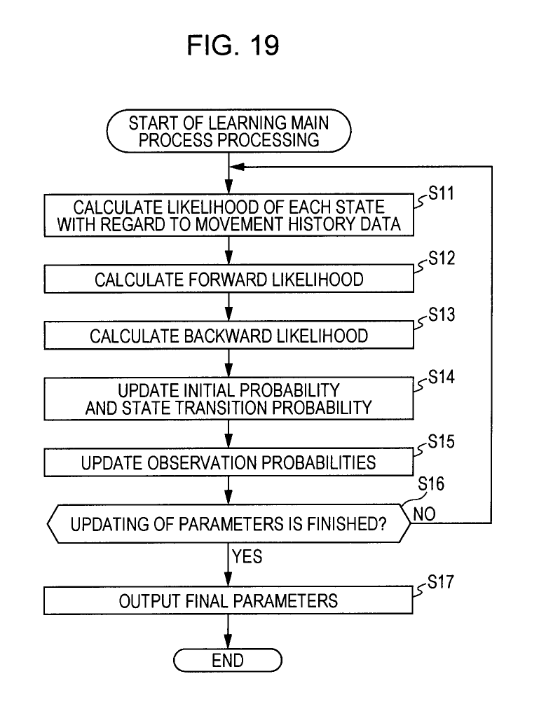

Next, processing of the learning main process section 23 (learning main process processing) will be described with reference to the flow chart of FIG. 19.

In the learning main process processing, first, in step S11, the learning main process section 23 calculates the likelihood of each state with regard to the movement history data. Specifically, using equation (3), the learning main process section 23 calculates the state likelihood P(sᵢ|xₜ) in a case where it is assumed that the position data xₜ at the time t in the movement history data is output at the time of transition to the state sᵢ of the HMM which represents the user activity model.

$$P ( {s}_{i} \vert {x}_{t} ) = \frac{1}{\sqrt{2 {{πσ}_{si} ( 1 )}^{2}}} exp ( - \frac{{( {x}_{t} ( 1 ) - {μ}_{si} ( 1 ) )}^{2}}{2 {{σ}_{si} ( 1 )}^{2}} ) \times \frac{1}{\sqrt{2 {{πσ}_{si} ( 2 )}^{2}}} exp ( - \frac{{( {x}_{t} ( 2 ) - {μ}_{si} ( 2 ) )}^{2}}{2 {{σ}_{si} ( 2 )}^{2}} ) … \times \frac{1}{\sqrt{2 {{πσ}_{si} ( D )}^{2}}} exp ( - \frac{{( {x}_{t} ( D ) - {μ}_{si} ( D ) )}^{2}}{2 {{σ}_{si} ( D )}^{2}} ) \qquad ( 3 )$$

Here, the time t represents the order of the time series data (the number of steps) and not the measurement time of the time series data and takes a value from 1 to T (the number of samples in the time series data).

In addition, D in equation (3) shows the number of dimensions of the movement history data. In this case, D=3 since the movement history data is three-dimensional data of time, latitude, and longitude. Then, xₜ(1), xₜ(2), and xₜ(3) represent time, latitude, and longitude of each of the movement history data xₜ. In addition, each of the output probability density functions of time, latitude, and longitude of the movement history data which are output at the time of transition to the state sᵢ follows a single normal distribution, and μₛᵢ(1) and σₛᵢ(1) represent the central value and the standard deviation in the time output probability density function. In addition, μₛᵢ(2) and σₛᵢ(2) represent the central value and the standard deviation in the latitude output probability density function, and μₛᵢ(3) and σₛᵢ(3) represent the central value and the standard deviation in the longitude output probability density function.

Here, equation (3) is an equation of a Baum-Welch maximum likelihood estimation method which is typically used.

In step S11, the learning main process section 23 calculates the state likelihood P(sᵢ|xₜ) using equation (3) with regard to the combination of all states sᵢ and the three-dimensional data xₜ.

Next, in step S12, the learning main process section 23 calculates a forward likelihood αₜ(sᵢ) of all of the state sᵢ for each time t. That is, the learning main process section 23 calculates the forward likelihood αₜ(sᵢ) of the state sᵢ at the time t using equations (4) and (5) in order from time 1 to the last time T.

α₁(sᵢ)=πₛᵢ (4)

$${α}_{t} ( {s}_{i} ) = {{\sum }_{j = 1}}^{M} {α}_{t - 1} ( {s}_{j} ) {a}_{ji} P ( {s}_{i} \vert {x}_{t} ) \qquad ( 5 )$$

Here, πₛᵢ in equation (4) represents the initial probability of the state sᵢ. In addition, aⱼᵢ in equation (5) represents the state transition probability from the state sⱼ to the state sᵢ. Here, initial values of the initial probability πₛᵢ and the state transition probability aⱼᵢ are, for example, applied from the outside. Equation (4) and equation (5) are equations of a forward algorithm of a Baum-Welch maximum likelihood estimation method which are typically used.

In step S13, the learning main process section 23 calculates a backward likelihood βₜ(sᵢ) of all of the state sᵢ for each time t. That is, the learning main process section 23 calculates the backward likelihood βₜ(sᵢ) of the state sᵢ at the time t using equations (6) and (7) in reverse order from the last time T to time 1.

$$\begin{matrix}{β}_{T} ( {s}_{i} ) = \frac{1}{M} & ( 6 ) \\ {β}_{t} ( {s}_{i} ) = {\sum }_{j = 1}^{M} {a}_{ij} P ( {s}_{i} \vert {x}_{t + 1} ) {β}_{t + 1} ( {s}_{j} ) & ( 7 )\end{matrix}$$

Equation (6) and equation (7) are equations of a backward algorithm of a Baum-Welch maximum likelihood estimation method which are typically used. In equation (6), the probabilities of each of the states sᵢ at time T are all the same.

In this manner, due to the processing from step S11 to step S13, each type of likelihood of the hidden Markov model is calculated with regard to the movement history data.

In step S14, the learning main process section 23 updates the initial probabilities and the state transition probabilities. That is, the learning main process section 23 updates the initial probabilities πₛᵢ of each of the states sᵢ and the state transition probabilities aⱼᵢ between each of the states respectively to initial probabilities πₛᵢ′ and the state transition probabilities aⱼᵢ′ determined using equation (8) and (9).

$$\begin{matrix}{π}_{si}^{′} = \frac{{α}_{1} ( {s}_{1} ) {β}_{1} ( {s}_{i} )}{{\sum }_{i = 1}^{M} {α}_{t} ( {s}_{i} )} & ( 8 ) \\ {a}_{ij}^{′} = \frac{{\sum }_{t = 1}^{T - 1} {α}_{t} ( {s}_{i} ) {a}_{ij} P ( {s}_{j} \vert {x}_{t + 1} ) {β}_{t + 1} ( {s}_{j} )}{{\sum }_{t = 1}^{T - 1} {α}_{t} ( {s}_{i} ) {β}_{t} ( {s}_{i} )} & ( 9 )\end{matrix}$$

Equation (8) and equation (9) are equations of a Baum-Welch maximum likelihood estimation method which are typically used.

In step S15, the learning main process section 23 updates the observation probabilities. That is, the learning main process section 23 updates the central values μₛᵢ(d) and the dispersions σₛᵢ(d)² of the output probability density functions of each of the states sᵢ respectively to central values μₛᵢ(d)′ and the dispersions σₛᵢ(d)′² determined using equation (10) and equation (11).

$$\begin{matrix}{{μ}_{si} ( d )}^{′} = \frac{{\sum }_{t = 1}^{T} {α}_{t} ( {s}_{i} ) {β}_{t} ( {s}_{i} ) {x}_{t} ( d )}{{\sum }_{t = 1}^{T} {α}_{t} ( {s}_{i} ) {β}_{t} ( {s}_{i} )} & ( 10 ) \\ {{σ}_{si} ( d )}^{′2} = \frac{{\sum }_{t = 1}^{T} {α}_{t} ( {s}_{i } ) {β}_{t} ( {s}_{i} ) {( {x}_{t} ( d ) - {{μ}_{si} ( d )}^{′} )}^{2}}{{\sum }_{t = 1}^{T} {α}_{t} ( {s}_{i} ) {β}_{t} ( {s}_{i} )} & ( 11 )\end{matrix}$$

Here, d in equation (10) and equation (11) represent the dimensions of the data, and in this case, d is either 1, 2, or 3. Equation (10) and equation (11) are equations of a Baum-Welch maximum likelihood estimation method which are typically used.

In step S16, the learning main process section 23 determines whether or not the updating of the parameters is finished. For example, in a case where the amount of increase in each likelihood is equal to or less than a threshold value and the convergence conditions of the updating of the parameters are satisfied, the learning main process section 23 determines that the updating of the parameters is finished. Alternatively, in a case where the processing from step S11 to step S15 has been repeatedly executed a prescribed number of times, it may be determined that the updating of the parameters is finished.

In step S16, in a case where it is determined that the updating of the parameters is not finished, the processing returns to step S11.

In step S11, the learning main process section 23 calculates the likelihood of each state based on the updated parameters. That is, the likelihood of each state is calculated based on data, which shows the initial probabilities πₛᵢ, the central values μₛᵢ(d), and the dispersions σₛᵢ(d)² of each of the states sᵢ and the state transition probabilities aⱼᵢ between each of the states, updated by the processing of steps S14 and S15.

After that, the processing of steps S12 to S15 is executed in the same manner. According to this, the updating of the parameters of the HMM is performed so that each type of likelihood of the series of the states sᵢ, that is, the state likelihood P(sᵢ|xₜ), the forward likelihood αₜ(sᵢ), and the backward likelihood βₜ(sᵢ), gradually increase and eventually are maximized. Then, in step S16, it is determined again whether or not the updating of the parameters is finished.

In step S16, in a case where it is determined that the updating of the parameters is finished, the processing progresses to step S17.

In step S17, the learning main process section 23 outputs the final parameters to the individual user model parameter memory section 12 and the destination and stopover detection section 25 (FIG. 1). That is, learning main process section 23 outputs the data, which shows the initial probabilities πₛᵢ, the central values μₛᵢ(d), and the dispersions σₛᵢ(d)² of each of the states sᵢ and the state transition probabilities aᵢⱼ between each of the states, which are determined last to the individual user model parameter memory section 12 and the destination and stopover detection section 25 (FIG. 1). After that, the learning main process processing ends.

Configuration Example of Learning Post-Process Section 24

Next, the details of the learning post-process section 24 will be described.

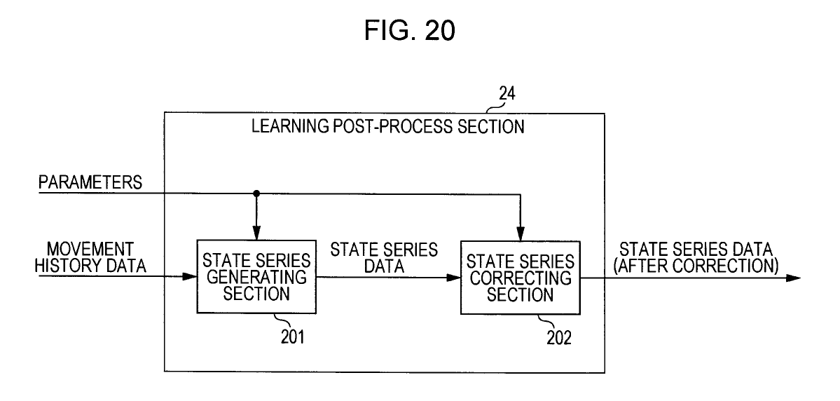

FIG. 20 is a block diagram illustrating a detailed configuration example of the learning post-process section 24.

The learning post-process section 24 is configured by a state series generating section 201 and a state series correcting section 202. In the state series generating section 201 and the state series correcting section 202, the parameters which the learning main process section 23 determined by learning are supplied.

The state series generating section 201 converts the movement history data with the movement attribute generated by the learning pre-process section 22 to time series data (state series data) of the state nodes of the user activity model, and supplies the data to the state series correcting section 202. Specifically, the state series generating section 201 recognizes the user activity model corresponding to each unit of the three-dimensional movement history data from the user activity model based on the parameters supplied from the learning main process section 23. Then, the state series generating section 201 sequentially supplies the user state nodes sᵢ to the state series correcting section 202 as a recognition result.

The state series correcting section 202 corrects the state series data supplied from the state series generating section 201 as necessary and supplies the state series data after correction to the destination and stopover detection section 25 (FIG. 1). In a case where the state series data is not corrected by the state series correcting section 202, the state series data supplied from the state series generating section 201 is supplied as it is to the destination and stopover detection section 25.

Processing of State Series Correcting Section 202

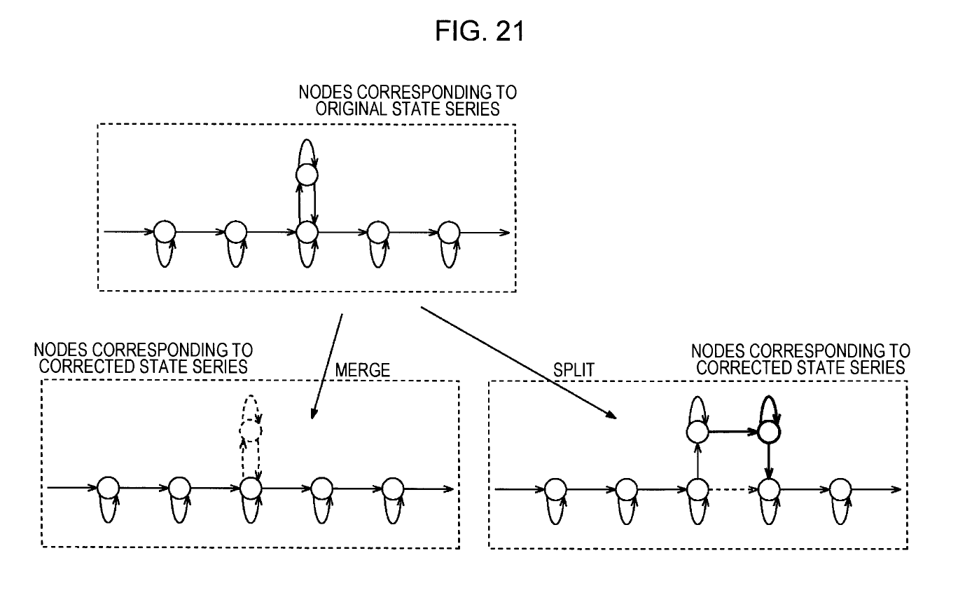

The correction processing of the state series data performed by the state series correcting section 202 will be described with reference to FIGS. 21 to 25.

FIG. 21 shows the correction processing using the state series correcting section 202.

In the embodiment, the state series data supplied from the state series generating section 201 is data which corresponds to the user movement history. The movement of the user is considered to be comparable to a left-to-right state transition model from one destination to another destination.

Therefore, the state series correcting section 202 performs correction to simplify the state series data supplied from the state series generating section 201 so that it becomes left-to-right state series data.

In order to correct the state series data so as to satisfy the left-to-right restrictions, the state series correcting section 202 initially searches whether or not there is a loop, that is, a portion which returns to the same state node in the state series data. Then, in a case where a loop is detected, the state series correcting section 202 merges (deletes the state node and absorbs into a parent node) or splits (separates by generating a new state node) the loop.

In more detail, in a case where the number of nodes in the loop is one, the state series correcting section 202 corrects the state series data by merging, and in a case where the number of nodes in the loop is two or more, the state series correcting section 202 corrects the state series data by splitting.

Loop Correction Processing of State Series Correcting Section 202

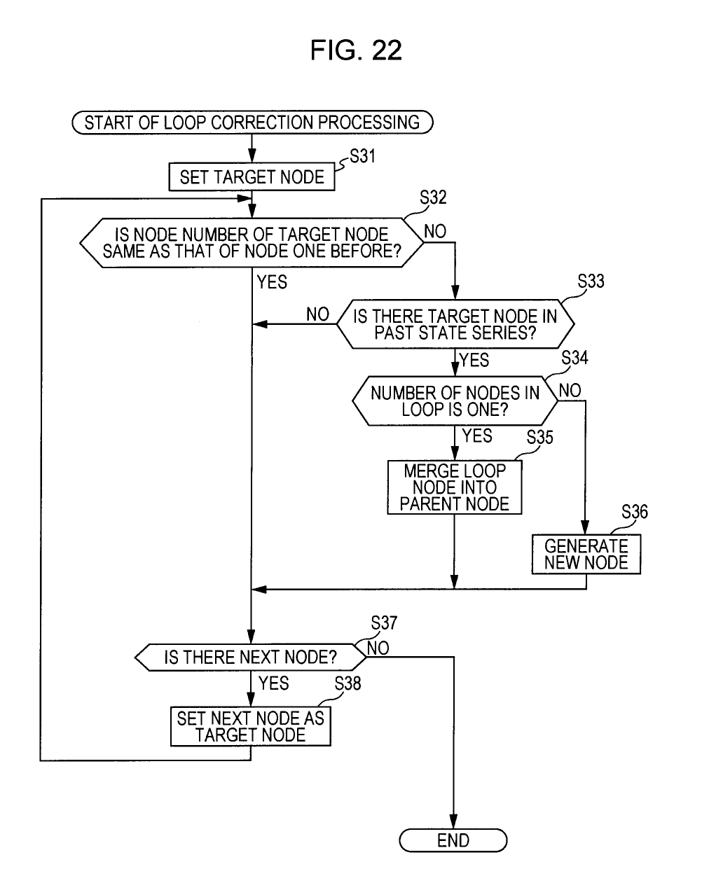

FIG. 22 shows a flow chart of the loop correction processing using the state series correcting section 202. The state series correcting section 202 has an internal memory which stores the state series data with a predetermined number of steps, and starts the processing when the state series data with a certain level of number of steps from the state series generating section 201 has accumulated in the internal memory.

Initially, in step S31, the state series correcting section 202 sets a target node with regard to the state series data supplied from the state series generating section 201. That is, the state series correcting section 202 selects the front state node from the state series data supplied from the state series generating section 201 and sets the front node as the target node.

In step S32, the state series correcting section 202 determines whether or not the node number of the target node is the same as that of the node one before. In a case where the state transition is self transition, the node number of the target node is the same. Accordingly, in other words, the state series correcting section 202 determines whether or not there is self transition. Here, in a case where the front state node is the target node, it is determined that the node number of the target node is the same as the node one before.

In step S32, in a case where the node number of the target node is the same as that of the node one before, the processing progresses to step S37 which will be described later.

On the other hand, in step S32, in a case where the node number of the target node is not the same as that of the node one before, the processing progressed to step S33, and the state series correcting section 202 determines if the target node exists in a past state series. When there is a loop in the state series data and the state series data loops and returns to a past state series, it is determined in step S33 that the target node exists in a past state series.

In step S33, in a case where it is determined that the target node does not exist in a past state series, the processing progresses to step S37 which will be described later.

On the other hand, in step S33, in a case where it is determined that the target node exists in a past state series, the processing progresses to step S34, and the state series correcting section 202 determines if the number of nodes in the loop is one.

In step S34, in a case where it is determined that the number of nodes in the loop is one, the state series correcting section 202 merges the node of the loop into a parent node (node to which it returns) in step S35.

In step S34, in a case where it is determined that the number of nodes in the loop is two or more, the state series correcting section 202 generates a new node and separates in step S36.

After the processing of step S35 or step S36, it is determined in step S37 if there is a node which follows the target node in the state series data.

In step S37, in a case where it is determined that there is a node which follows the target node, the state series correcting section 202 sets the following node as the target node in step S38 and the processing returns to step S32.

On the other hand, in step S37, in a case where it is determined that there is not a node which follows the target node, that is, in a case where all of the state nodes of the state series data supplied from the state series generating section 201 have been searched for loops, the processing ends.

By performing the above processing, the state series correcting section 202 corrects the state series data supplied from the state series generating section 201 and the state series data after correction is output.

Here, in the embodiment, it is determined whether the state series correcting section 202 corrects a detected loop by either merging or splitting depending on whether or not the number of nodes in the loop is one. However, in a case of correction by either merging or splitting, correction by either merging or splitting may be determined by another determination standard such as if the likelihood will increase, the complexity of the learning model, or the like.

In addition, in a case where other information is used, it is possible that correction by either merging or splitting is determined using the information. For example, even in the case where there is one node in the loop, for example, it may be an important node such as a destination candidate node. In such a case, splitting processing is to be performed instead of merging. In addition, even in the case where the number of nodes in the loop is two or more, neither of the nodes may be important nodes. In addition, alternatively, cases may be considered such as there being a limit on the total number of nodes and it not being possible to increase the number of nodes. In such a case, modifications may be made according to the situation.

Description of Other Correction Processing Using State Series Correcting Section 202

Next, an example of another correction processing of the state series data using the state series correcting section 202 will be described.

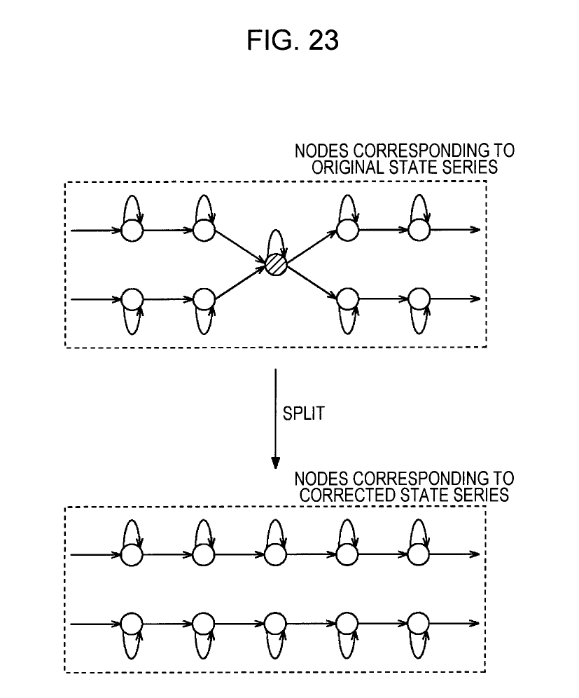

FIG. 23 shows as example of processing where a common node where one node is common to a plurality of series is corrected.

In the state transition diagram in the upper level of FIG. 23, the middle node shown with diagonal lines is the common node. That is, the nodes before and after the common node are each different nodes. As shown in the state transition diagram of the lower level of FIG. 23, the state series correcting section 202 splits (separates by generating a new state node) the common node and corrects the original state series data into two series.

In a case where the likelihood of the node is low, it may be the case that the node was originally to be separate nodes but the model lapsed into local minima during learning due to the initial conditions, an insufficient number of nodes in the model, or the like, and the node became the common node such as this. In a case where the node likelihood of the node represented by three-dimensional data is low, it has a meaning of a case where there is a large distance between the position shown by the node (central position) and the actual data position.

In the state series correcting section 202, by performing the processing of splitting the common node as the correction processing of the state series data, it is possible to resolve the common node generated by the initial conditions, an insufficient number of nodes in the model, or the like. In other words, it is possible to realize processing, which is not possible to realize in the constraint conditions using the learning main process section 23 (ergodic HMM using the sparse limitation), in an ex-post (additional) manner using the state series correcting section 202.

Common Node Correction Processing of State Series Correcting Section 202

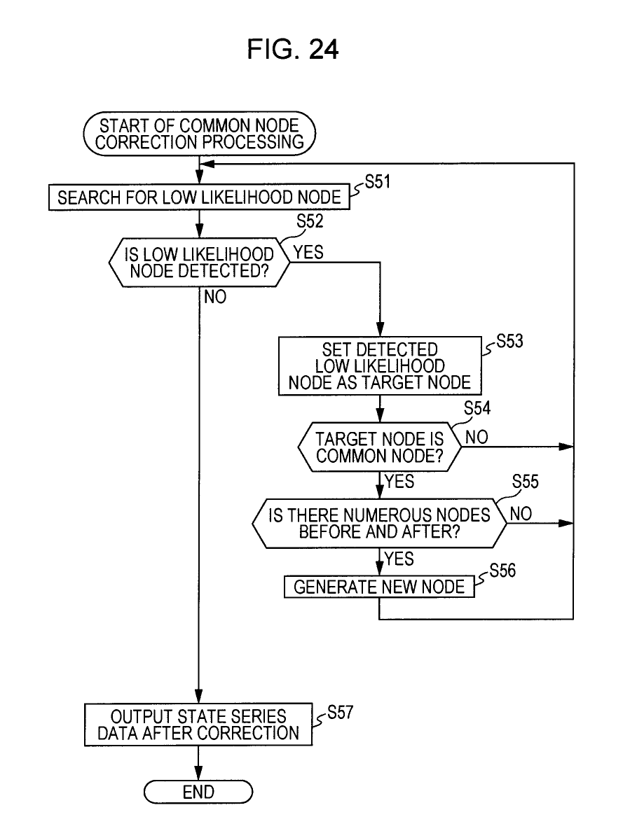

FIG. 24 shows a flow chart of common node correction processing using the state series correcting section 202. The processing starts when all of the state series data from the state series generating section 201 is accumulated in the internal memory.

First, in step S51, the state series correcting section 202 searches for a low likelihood node, which is the node where the likelihood is equal to or lower than a predetermined value, from the state series data stored in the internal memory and the processing progresses to step S52. In the embodiment, the node where there is a large distance between the central position of the node obtained by learning and the actual data position is the low likelihood node.

In step S52, the state series correcting section 202 determines if the low likelihood node has been detected.

In step S52, in a case where it is determined that the low likelihood node has been detected, the processing progresses to step S53, and the state series correcting section 202 sets the detected low likelihood node as the target node.

In step S54, the state series correcting section 202 determines if the target node is the common node. In step S54, in a case where it is determined that the target node is not the common node, the processing returns to step S51.

On the other hand, in step S54, in a case where it is determined that the target node is the common node, the processing progresses to step S55 and the state series correcting section 202 determines if there are numerous nodes before and after.

In step S55, in a case where it is determined that there are not numerous nodes either before or after, the processing returns to step S51. On the other hand, in step S55, in a case where it is determined that there are numerous nodes either before or after, the processing progresses to step S56 and the state series correcting section 202 corrects the original state series data into two series by generating a new node. Also after the completion of the processing of step S56, the processing returns to step S51.

Then, by repeatedly executing the processing from steps S51 to S56 described above, all of the low likelihood nodes are sequentially detected and the common nodes are split.

In a case where all of the low likelihood nodes have been detected, in step S52, it is determined that the low likelihood nodes have not been detected and the processing progresses to step S57. Then, in step S57, the state series correcting section 202 outputs the state series data after the correction where the correction has been performed with regard to the original state series data and the processing ends. In a case where not even one low likelihood node is detected, the original state series data is output as it is.

The state series correcting section 202 performs the common node correction processing such as above and it is possible for the state series data supplied from the state series generating section 201 to be corrected.

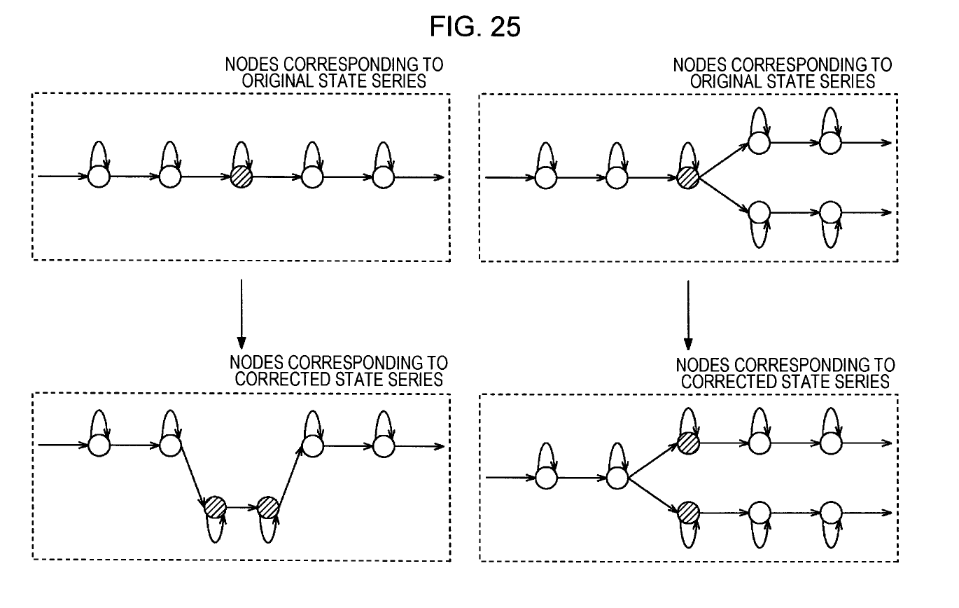

In addition, in the processing shown in FIGS. 23 and 24, the node is split only in the case where there are numerous series both before and after. However, as shown in the right side of FIG. 25, even in a case where there is numerous series only either before or after, the node may be split.

In addition, as shown on the left side of FIG. 25, even in a case where there is not numerous series both before and after, splitting may be performed in a case where splitting increases the node likelihood. In either case, there is a condition that the likelihood is higher due to the splitting than before the correction. In addition, as shown on the left side of FIG. 25, in splitting in the case where there is not numerous series both before and after, there is also a condition that self transition is generated in the correction target node so that the number of steps before and after the correction does not change.

According to the correction processing of the state series data using the state series correcting section 202 as above, it is possible to perform correction in cases where not only a new constraint is added to the state series data but also in cases such as where it is not possible to sufficiently increase the likelihood as the model has lapsed into local minima in learning.

In the processing shown in FIGS. 23 and 24, a check of the likelihood is performed with regard to the learning data, but the check of the likelihood may be performed using other data obtained at the same time as the learning data. If the data is data from other data series which has an effect on the state transition in the learning model, normally, learning is performed as a multi-modal model. However, if the contribution of the data series is not large or unclear, learning is performed only using data with a large contribution, and it is possible to prevent time series data with a low contribution having an effect on the learning model which is more than necessary by the effect being reflected only when the state series correcting section 202 corrects the time series data obtained from the learnt model.

Processing of Destination and Stopover Detection Section 25

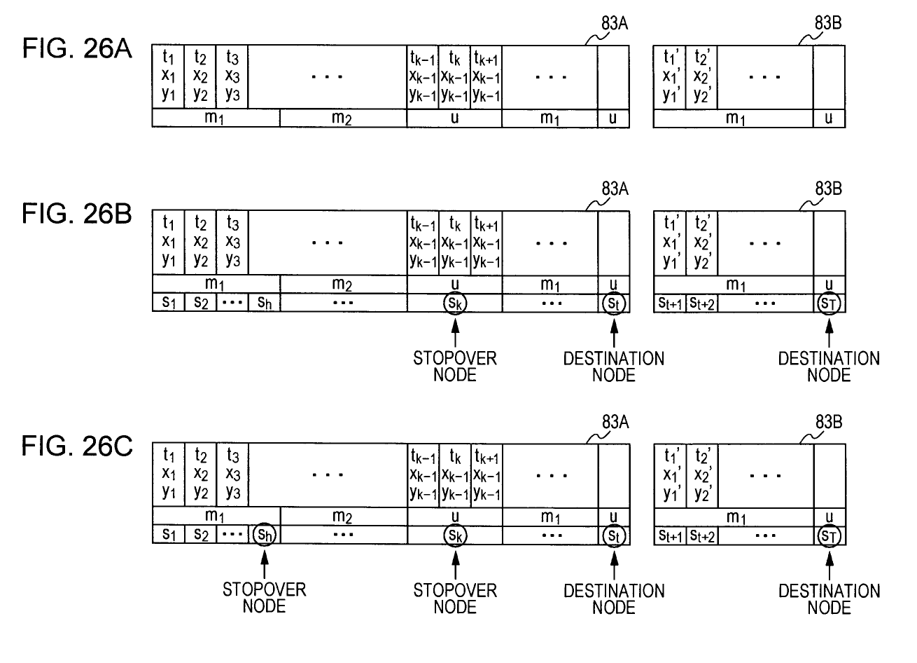

Next, processing of the destination and stopover detection section 25 will be described with reference to FIGS. 26A to 26C.

As described above, the learning main process section 23 learns the parameters of the user activity model with movement history data (with the movement attribute) after the processing of division and holding of the movement history data has been performed as the learning data. Then, the learning post-process section 24 generates state series data corresponding to the movement history data using the parameters determined by learning.

FIG. 26A shows the movement history data 83A and 83B with the movement attribute, after the division and the holding of the movement history data has been performed by the learning pre-process section 22, which is shown in the lower level of FIG. 8.

FIG. 26B is a diagram showing the movement history data 83A and 83B with the movement attribute which is shown in the lower level of FIG. 8 together with the corresponding state series data.

In the movement history data 83A with the movement attribute, s₁, s₂, . . . , sₖ, . . . , sₜ correspond to state series nodes. In the movement history data 83B with the movement attribute, sₜ₊₁, sₜ₊₂, . . . , s_{T} correspond to state series nodes.

The destination and stopover detection section 25 detects the state nodes which correspond to the last “stationary state (u)” three-dimensional data in one grouping of the movement history data with the movement attribute and applies a destination attribute. In the example of FIG. 26B, the destination attribute is applied in regard to the state nodes sₜ in the movement history data 83A with the movement attribute and the states nodes s_{T} in the movement history data 83B with the movement attribute. Both the state nodes sₜ and the states nodes s_{T} are state nodes where the stationary state has continued for the stationary threshold time or more. In this manner, the state nodes, which correspond to the movement history data where the stationary state has continued for the stationary threshold time or more, are estimated as destinations using the destination and stopover detection section 25.

Here, in the division processing described with reference to FIG. 8, the last plurality of “movement states” which are equal to or more than the stationary threshold time in the divided movement history data are reduced to one “movement state”. However, in the division processing, all of the last plurality of “movement states” which are equal to or more than the stationary threshold time in the movement history data may be deleted. When describing using the example of FIG. 26A, the last “stationary state (u)” three-dimensional data in each of the movement history data 83A and 83B with the movement attribute may be omitted. In this case, the destination and stopover detection section 25 applies the destination attribute to the state node which corresponds to the last three-dimensional data in one grouping of the movement history data with the movement attribute. When describing using the example of FIG. 26B, the state node sₜ₋₁ which is one before the state node sₜ in the movement history data 83A with the movement attribute and the state node s_{T-1} which is one before the state node s_{T} in the movement history data 83B with the movement attribute may be set as the destinations.

The destination and stopover detection section 25 also detects the state nodes which correspond to a certain intermediate “stationary state (u)” three-dimensional data in one grouping of the movement history data with the movement attribute and applies a stopover attribute. That is, the state nodes, which correspond to the movement history data where the continuous time of the stationary state is less than one division threshold time, are estimated as stopovers. When describing using the example of FIG. 26B, the state node sₖ in the movement history data 83A with the movement attribute is set as the stopover.

Here, as shown in FIG. 26C, when the movement means is changed, the destination and stopover detection section 25 may apply the stopover attribute also to the last state node sₕ before the change.

Processing of Learning Block 11

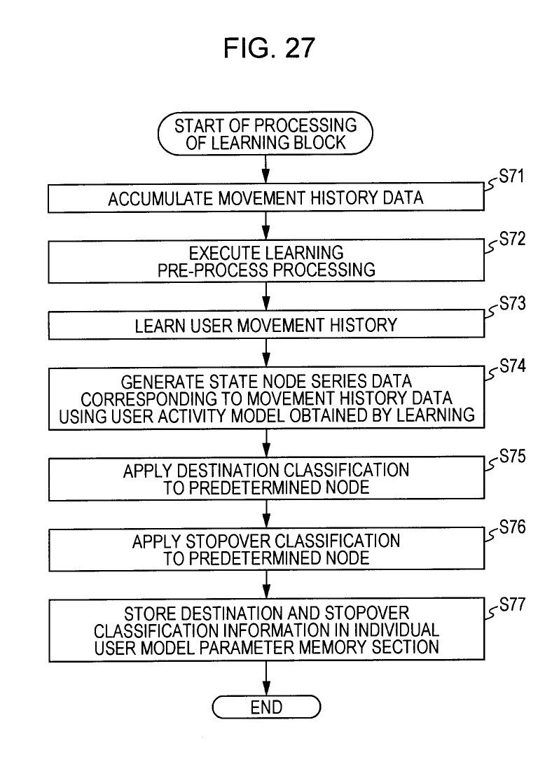

The processing of the entire learning block 11 will be described with reference to the flow chart of FIG. 27.

First, in step S71, the history data accumulating section 21 accumulates the movement history data supplied from the sensor device as the learning data.

In step S72, the learning pre-process section 22 executes the learning pre-process processing described with reference to FIG. 18. That is, the processing of the connection and division of the movement history data accumulated in the history data accumulating section 21, the application of the movement attribute of either the “stationary state” or the “movement state” to each unit of the three-dimensional data which configures the movement history data, and the like is performed.

In step S73, the learning main process section 23 learns the user movement history. That is, the learning main process section 23 determines the parameters when the user movement history is modeled as the probability state transition model (HMM) as the user activity model. The parameters obtained by learning are supplied to the learning post-process section 24 and the individual user model parameter memory section 12 and are stored in the individual user model parameter memory section 12.

In step S74, the learning post-process section 24 generates the state node series data which corresponds to the movement data using the user activity model obtained by learning.

In step S75, the destination and stopover detection section 25 applies the destination attribute to the predetermined state node of the state series nodes which correspond to the movement history data with the movement attribute. More specifically, the destination and stopover detection section 25 applies the destination attribute to the state node which corresponds to the movement history data where the stationary state has continued for the stationary threshold time or more.

In step S76, the destination and stopover detection section 25 applies the stopover attribute to the predetermined state node of the state series nodes which correspond to the movement history data with the movement attribute. More specifically, the destination and stopover detection section 25 applies the stopover attribute to the state node which corresponds to the movement history data where the continuous time of the stationary state is less than the stationary threshold time.

In step S77, the destination and stopover detection section 25 stores the information on the attribute of the destinations and the stopovers applied to the state nodes in the individual user model parameter memory section 12 and the processing ends.

Processing of Prediction Main Process Section 33

Next, processing performed by the prediction block 13 will be described.

Firstly, tree search processing beyond the current location node using the prediction main process section 33 will be described.

The tree search processing beyond the current location node is processing where the destination nodes which are able to be arrived at and a route to the destination node are determined from the current location node estimated by the current location node estimation section 41 of the prediction main process section 33. The destination nodes which are able to be arrived at exist in a tree structure which is configured by the nodes for which it is possible to transition to from the current location node. Accordingly, it is possible to predict the destination by searching for the destination node from within the state nodes which configure the tree structure. In addition, in the tree search processing beyond the current location node, in a case where the state node with the stopover attribute (referred to below as a stopover node) is detected, the route to the stopover is also stored.

Each of the states sᵢ of the HMM obtained by learning represent a predetermined point (position) on a map, and when the state sᵢ and the state s are connected, it is possible to consider that a route moving from the state sᵢ to the state sⱼ is represented.

In this case, it is possible to classify each point which corresponds to the states sᵢ as either a terminal point, a pass-through point, a branching point, or a loop. The terminal point is a point where the probability of other than self transition is extremely low (the probability of other than self transition is less than or equal to a predetermined value) and there is no point which is able to be moved to next. The pass-through point is a point where there is one significant transition other than self transition, in other words, where there is one point which is able to be moved to next. The branching point is a point where there are two or more significant transitions other than self transition, in other words, where there are two or more points which are able to be moved to next. The loop is a point which matches with any portion of the routes which has been passed through up to the loop.

In a case where the route to the destination is searched for, in a case where there are different routes, it is desirable that information such as the necessary times for each of the routes is presented. Therefore, the following conditions are set for searching for possible routes without excess or deficiency.

(1) A route which has branched off once is viewed as another route even in a case where it is merged into again.

(2) In a case where the searched route reaches the branching point, a non-searched list is created and searching of the branches in the non-searched list is performed.

(3) In a case where the terminal point or the loop appears in the route, the searching of the route ends. Here, a case of the route returning to the point one before from the current point is included as the loop.

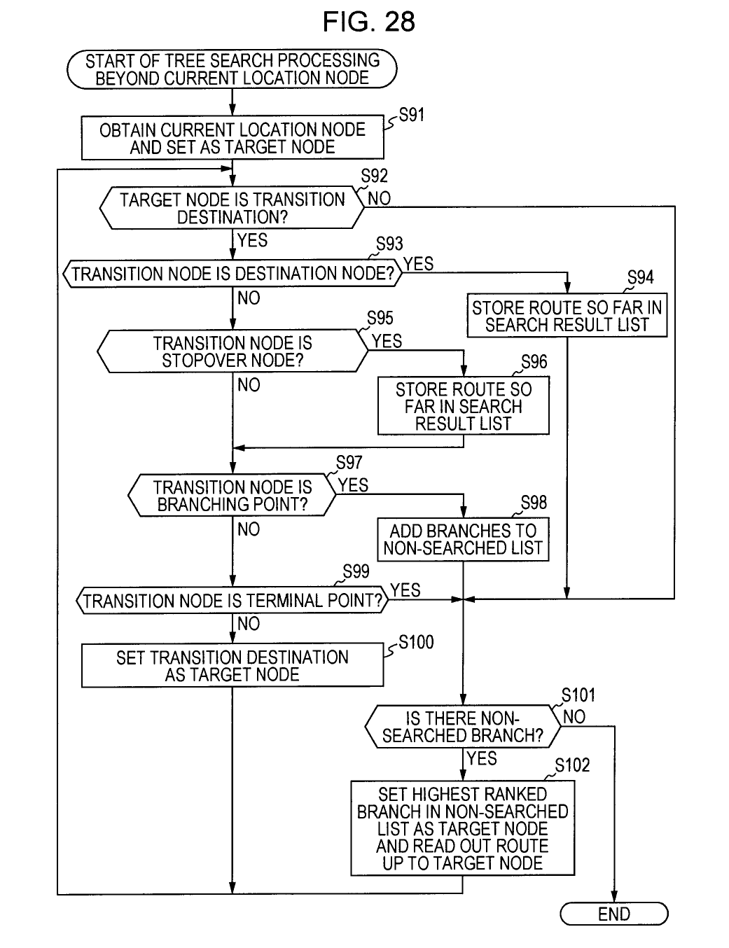

FIG. 28 is a flow chart of the tree search processing beyond the current location node using the destination and stopover prediction section 42 of the prediction main process section 33.

In the processing of FIG. 28, first, in step S91, the destination and stopover prediction section 42 obtains the current location node estimated using the current location node estimation section 41 of the prediction main process section 33 and sets the target node which is the node to be targeted.

In step S92, the destination and stopover prediction section 42 determines if there is a transition destination beyond the target node. In a case where it is determined that there is no transition destination beyond the target node in step S92, the processing progresses to step S101 which will be described later.

On the other hand, in a case where it is determined that there is a transition destination beyond the target node in step S92, the processing progresses to step S93 and the destination and stopover prediction section 42 determines if the transition destination is a destination node.

In a case where it is determined that the transition destination is a destination node in step S93, the processing progresses to step S94 and the destination and stopover prediction section 42 stores the route so far (state node series) in a search result list in the internal memory. After step S94, the processing progresses to step S101.

On the other hand, in a case where it is determined that the transition destination is not a destination node in step S93, the processing progresses to step S95 and the destination and stopover prediction section 42 determines if the transition destination is a stopover node.

In a case where it is determined that the transition destination is a stopover node in step S95, the processing progresses to step S96 and the destination and stopover prediction section 42 stores the route so far (state node series) in the search result list in the internal memory.

In order to output the representative route, the arrival probability and the necessary time to the destination as the prediction result, it is sufficient if only the routes when the transition destination is the destination are stored in the search result list. However, by also storing the routes when the transition destination is the stopover, it is possible to promptly determine the route, the probability and the time to the stopover when necessary.

In a case where it is determined that the transition destination is not a stopover node in step S95 or after step S96, the processing progresses to step S97 and the destination and stopover prediction section 42 determines if the transition destination is the branching point.

In a case where it is determined that the transition destination is the branching point in step S97, the processing progresses to step S98 and the destination and stopover prediction section 42 stores (adds) the two state nodes of the branches in the non-searched list in the internal memory. After step S98, the processing progresses to step S101. Here, since there is the loop in a case where the branch is any of the state nodes of the searched route, the destination and stopover prediction section 42 does not store the state node of the branch in the non-searched list.

In a case where it is determined that the transition destination is not the branching point in step S97, the processing progresses to step S99 and the destination and stopover prediction section 42 determines if the transition destination is the terminal point. In a case where it is determined that the transition destination is the terminal point in step S99, the processing progresses to step S101.

On the other hand, in a case where it is determined that the transition destination is not the terminal point in step S99, the processing progresses to step S100, and the destination and stopover prediction section 42 sets the state node of the transition destination as the target node and the processing returns to step S92. That is, in a case where the transition destination is neither the destination node, the stopover node, the branching point, nor the terminal point, the state node of the search target is advanced to the state node following the transition destination.

In a case where the processing progresses to step S101 after the processing of steps S94, S98, or S99, the destination and stopover prediction section 42 determines if there is the state node registered in the non-searched list, that is, if there is a non-searched branch.

In a case where it is determined that there is a non-searched branch in step S101, the processing progresses to step S102, and the destination and stopover prediction section 42 set the state node of the non-searched branch with the highest ranking in the non-searched list as the target node and reads out the route to the target node. Then, the processing returns to step S92.

On the other hand, in a case where it is determined that there is no non-searched branch in step S101, the tree search processing ends.

As above, in the tree search processing, processing is performed where all of the state nodes are searched with the current location node as a start point to the destination node or to the terminal nodes (terminal points) where there is no transition destination in the tree structure which is formed by the state nodes for which it is possible to transition to from the current location node of the user. Then, the route from the current location of the user to the destination is stored in the search result list as the state node series from the current location node. Here, the tree search processing may be searching until the number of searches reaches a predetermined number of times which is a completion condition.

Example of Tree Search Processing

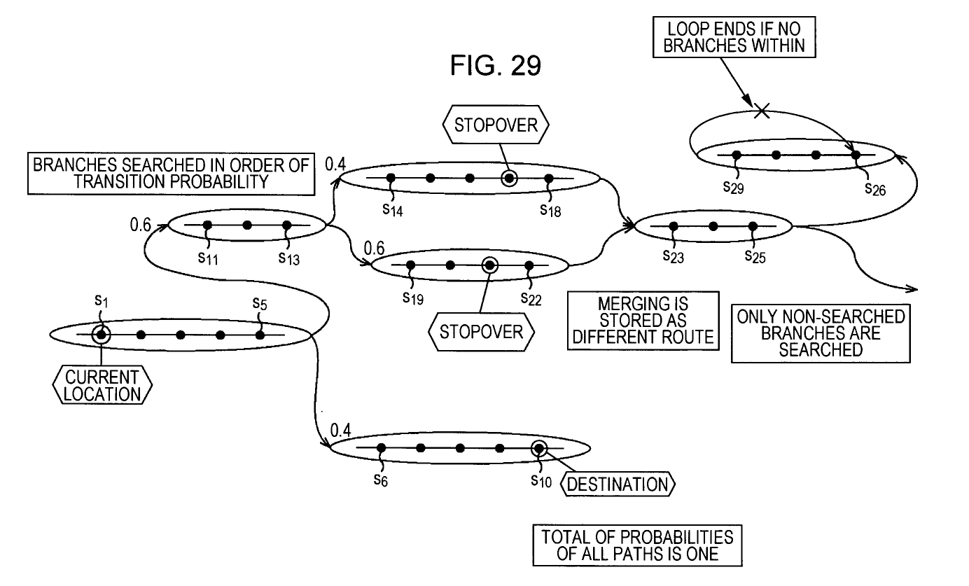

The tree search processing of the destination and stopover prediction section 42 will be further described with reference to FIG. 29.

In the example of FIG. 29, in a case where the state s₁ is the current location, at least the next three routes are searched for. A first route is a route (referred to below as a route A) from the state s₁ to the state s₁₀ via the state s₅, the state s₆, and the like. A second route is a route (referred to below as a route B) from the state s₁ to the state s₂₉ via the state s₅, the state s₁₁, the state s₁₄, the state s₂₃, and the like. A third route is a route (referred to below as a route C) from the state s₁ to the state s₂₉ via the state s₅, the state s₁₁, the state s₁₉, the state s₂₃, and the like.

The destination and stopover prediction section 42 calculates the probability that each of the searched routes is selected (route selection probability). The route selection probability is determined by the sequential multiplication of the transition probabilities between the states which configure the routes. Here, since only the cases of transition to the next state are considered and it is not necessary to consider the cases of being stationary at the location, the route selection probability is determined using the transition probabilities [aᵢⱼ] standardized by removing the self transition probabilities from the state transition probabilities aᵢⱼ of each state determined by learning.

It is possible to represent the transition probabilities [aᵢⱼ] standardized by removing the self transition probabilities using equation (12).

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 12 )$$

Here, δ represents a Kronecker function and is a function which becomes one only when the suffixes i and j match and becomes zero otherwise.

Accordingly, for example, in a case where the state transition probabilities aᵢⱼ of the state s₅ in FIG. 29 has a self transition probability a_{5,5}=0.5, a transition probability a_{5,6}=0.2, and a transition probability a_{5,11}=0.3, the transition probability [a_{5,6}] and the transition probability [a_{5,11}] in the case where the state s₅ branches to the state s₆ or the state s₁₁ respectively are 0.4 and 0.6.

When the node numbers i of the states sᵢ of the searched route are (y₁, y₂, . . . , yₙ), it is possible to represent the route selection probability using equation (13) by using the standardized transition probabilities [aᵢⱼ].

$$\begin{matrix}P ( {y}_{1} , {y}_{2} , … , {y}_{n} ) = [ {a}_{{y}_{1} {y}_{2}} ] [ {a}_{{y}_{2} {y}_{3}} ] … [ {a}_{{y}_{n - 1} {y}_{n}} ] \\ = {\prod }_{i = 1}^{n - 1} [ {a}_{y - 1} {y}_{i} ]\end{matrix} \qquad ( 13 )$$

Here, actually, since the transition probabilities [aᵢⱼ] standardized at the pass-through point is one, it is sufficient if the route selection probability is the sequential multiplication of the transition probabilities [aᵢⱼ] standardized when branching. Accordingly, it is possible for the destination and stopover prediction section 42 to calculate the selected route selection probability using equation (13) while at the same time executing the tree search processing of FIG. 28.

In the example in FIG. 29, the selection probability of route A is 0.4. In addition, the selection probability of route B is 0.24=0.6×0.4. The selection probability of route C is 0.36=0.6×0.6. Then, the total of the calculated route selection probabilities is 1=0.4+0.24+0.36, and it is understood that it is possible to realize searching without excess or deficiency.

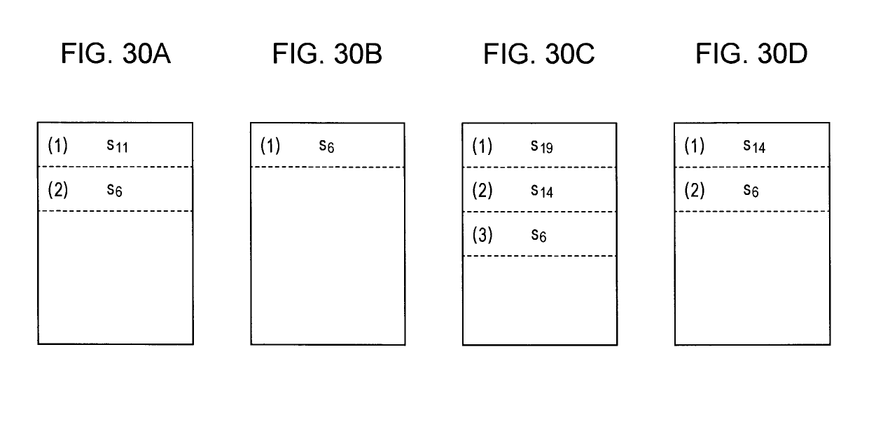

In the example in FIG. 29, the target node sequentially progresses from the current location state s₁, and when the state s₄ is the target node, step S98 of FIG. 28 is executed since the transition destination state s₅ is the branching point, and the state s₆ and the state s₁₁ of the branches are stored in the non-searched list as shown in FIG. 30A. Here, since the selection probability of the state s₁₁ is the higher out of the state s₆ and the state s₁₁, the state s₁₁ is stored at the top rank in the non-searched list.

Then, step S101 and step S102 of FIG. 28 are executed, the state s₁₁ stored in the top rank in the non-searched list is set as the target node, and the routes beyond the state s₁₁ are searched. When the state s₁₁ is set as the target node, the state s₁₁ is deleted from the non-searched list as shown in FIG. 30B.

Then, when the search progresses with the state s₁₁ as the target node, step S98 of FIG. 28 is executed since the branches of the state s₁₄ and the state s₁₉ are detected, and the state s₁₄ and the state s₁₉ are stored in the non-searched list. At this time, the state s₁₄ and the state s₁₉ are stored in the highest rank in the current non-searched list, and in addition, since the selection probability of the state s₁₉ is the higher out of the state s₁₄ and the state s₁₉, the state s₁₉ is stored at a higher rank than the state s₁₄. Accordingly, the non-searched list becomes as is shown in FIG. 30C.

Below, in the same manner, step S101 and step S102 of FIG. 28 are executed, the state s₁₉ stored in the top rank in the non-searched list is set as the target node, and the routes beyond the state s₁₉ are searched. When the state s₁₉ is set as the target node, the state s₁₉ is deleted from the non-searched list as shown in FIG. 30D.

As above, the tree search processing using the destination and stopover prediction section 42 executes processing using a depth priority algorithm which searches from the routes of the branches with a higher selection probability by registering the detected branches at the highest rank in the non-searched list.

Here, as the depth of the search gets deeper, in other words, as the levels of the lower ranks with the current location node as the highest rank gets deeper, it is considered that it is difficult to search all. In the case such as this, for example, conditions may be added such as 1) branches with low transition probabilities are not searched, 2) routes with low occurrence probabilities are not searched, 3) a limit is added to the depth of the search, 4) a limit is added to the number of branches searched, and the search ends at an intermediate point.

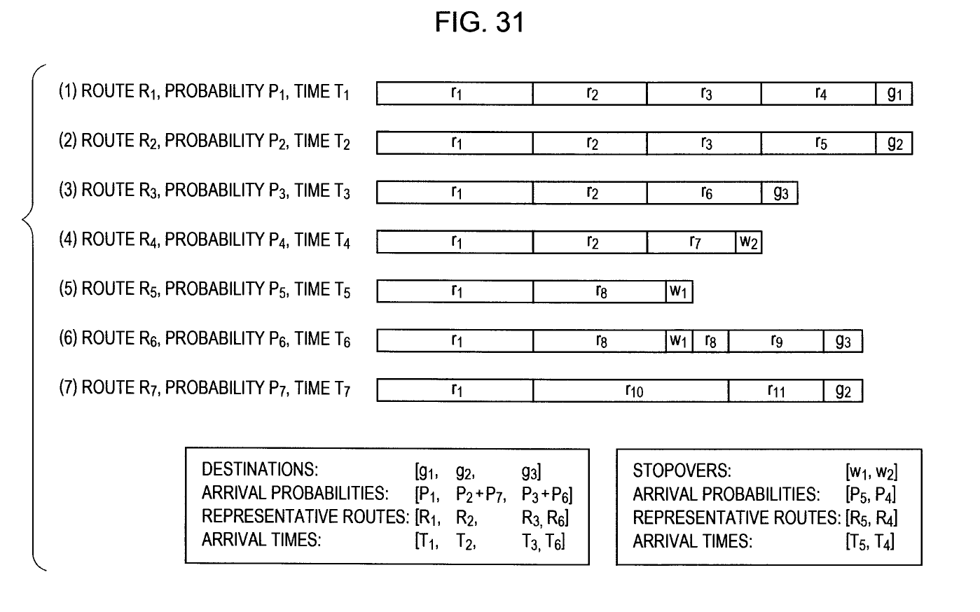

FIG. 31 shows an example of the search result list of the tree search processing.

By performing tree search processing using the depth priority algorithm, the routes with the highest selection probabilities are registered in order in the search result list.

In the example of FIG. 31, in a first in the search result list, a route R₁ to a destination g₁ (r₁, r₂, r₃, and r₄) is registered with a probability of the route R₁ being selected as P₁ and a time taken to the destination g₁ using the route R₁ as T₁. In a second in the search result list, a route R₂ to a destination g₂ (r₁, r₂, r₃, and r₅) is registered with a probability of the route R₂ being selected as P₂ and a time taken to the destination g₂ using the route R₂ as T₂. In a third in the search result list, a route R₃ to a destination g₃ (r₁, r₂, and r₆) is registered with a probability of the route R₃ being selected as P₃ and a time taken to the destination g₃ using the route R₃ as T₃.

In a fourth in the search result list, a route R₄ to a stopover w₂ (r₁, r₂, and r₇) is registered with a probability of the route R₄ being selected as P₄ and a time taken to the stopover w₂ using the route R₄ as T₄. In a fifth in the search result list, a route R₅ to a stopover w₁ (r₁ and r₈) is registered with a probability of the route R₅ being selected as P₅ and a time taken to the stopover w₁ using the route R₅ as T₅.

In a sixth in the search result list, a route R₆ to the destination g₃ (r₁, r₈, w₁, r₈, and r₉) is registered with a probability of the route R₆ being selected as P₆ and a time taken to the destination g₃ using the route R₆ as T₆. In a seventh in the search result list, a route R₇ to a destination g₂ (r₁, r₁₀, and r₁₁) is registered with a probability of the route R₇ being selected as P₇ and a time taken to the destination g₂ using the route R₇ as T₇.

The probabilities that each of the routes to the destinations or the stopovers is selected are calculated using equation (13) described above. Furthermore, in a case where there is a plurality of routes to the destination, the total of the selection probabilities of the plurality of routes to the destination becomes a destination arrival probability.

Accordingly, in the example in FIG. 31, in a case where the route R₂ is used to go to the destination g₂, since a case of using the route R₇ is also possible, the arrival probability of the destination g₂ is (P₂+P₇). In the same manner, in a case where the route R₃ is used to go to the destination g₃, since a case of using the route R₆ is also possible, the arrival probability of the destination g₃ is (P₃+P₆). Here, the arrival probability to the destination g₁ is the same as the probability P₁ that the route R₁ is selected.

Processing of Prediction Post-Process Section 34

Next, processing performed by the prediction post-process section 34 will be described.

Determining of the time taken when moving to the destination or the stopover using the selected route will be described.

For example, the current time t₁ at the current location is set as the state s_{y1} and the route determined at times (t₁, t₂, . . . , t_{g}) are set as (s_{y1}, s_{y2}, . . . , s_{yg}). In other words, the node number i of the states sᵢ of the determined route are set as (y₁, y₂, . . . , y_{g}). Below, for simplicity, there are cases where the states sᵢ which are equivalent to positions are simply represented by the node numbers i.

Since the current position y₁ at the current time t₁ is set by the current location node estimation section 41, a probability P_{y1}(t₁) that the current position at the current time t₁ is y₁ is P_{y1}(t₁)=1.

In addition, a probability of a different state other than y₁ at the current time t₁ is zero.

On the other hand, it is possible to represent the probability P_{yn}(tₙ) of the node number yₙ at a predetermined time tₙ as

P_{y}_{ₙ}(tₙ)=P_{y}_{ₙ}(tₙ−1)a_{y}_{ₙ}_{y}_{ₙ}+P_{y}_{_{n−1}}(tₙ−1)a_{y}_{_{n−1}}_{y}_{ₙ} (14)

The first item on the right side of equation (14) represents a probability in a case of self transition in the original position yₙ and the second item on the right side represents a probability in a case of transitioning to the position yₙ from the previous position yₙ₋₁. In equation (14), the calculating of the route selection probabilities is different and the state transition probability aᵢⱼ obtained by learning is used as it is.

It is possible to represent a prediction value <t_{g}> of the time t_{g} when arriving at the destination y_{g} using a “probability of moving to the destination y_{g} at the time t_{g} in the previous position y_{g-1} of the destination y_{g} at an immediately previous time t_{g-1}” as

$$〈 {t}_{g} 〉 = {\sum }_{t} {t}_{g} ( \frac{{P}_{{x}_{g - 1}} ( {t}_{g - 1} - 1 ) {a}_{{x}_{g - 1} {x}_{g}}}{{\sum }_{t} {P}_{{x}_{g - 1}} ( {t}_{g} - 1 ) {a}_{{x}_{g - 1} {x}_{g}}} ) \qquad ( 15 )$$

That is, the prediction value <t_{g}> is represented as an expected value of the time from the current time to “when moving to the state s_{yg} at the time t_{g} in the previous state s_{yg-1} of the state s_{yg} at an immediately previous time t_{g-1}”.

Due to the above, the time taken when moving to the predetermined destination or stopover using the selected route is determined by the prediction value <t_{g}> of equation (15) described above.

Using the example of FIG. 31, representative route selection processing of selecting as the representative route in a case where the route to the destination is searched will be described.

In a case where the search result list is obtained as in FIG. 31, since the routes with the highest selection probabilities are registered in order (from the highest rank) in the search result list, the first to the third in the search result list with selection probability ranked higher and different destinations are output as the prediction result. That is, the destination g₁ and the route R₁, the destination g₂ and the route R₂, and the destination g₃ and the route R₃ are selected as the destinations and the representative routes.

Next, the fourth and the fifth in the search result list are skipped since the fourth and the fifth are the routes to the stopovers, and whether the route R₆ of the sixth in the search result list for arriving at the destination g₃ is to be set as the representative route is examined. The route R₆ uses the stopover w₁ which is not included in the route R₃ to the same destination g₃ which is already selected as the representative route. Accordingly, the route R₆ for arriving at the destination g₃ is also selected as the representative route.

Next, whether the route R₇ of the seventh in the search result list for arriving at the destination g₂ is to be set as the representative route is examined. The route R₇ has the same destination g₂ for which the representative route has already been selected and does not pass through the predetermined stopover. Accordingly, the route R₇ for arriving at the destination g₂ is not selected as the representative route.

In this manner, in the representative route selection processing, it is possible that the routes which are similar and pass through the substantially the same route are not presented, and the routes which are considered advantageous to the user and pass through different stopovers are presented as the prediction result even if the routes are to the same destination.

Here, the searching of the route R₆ of the sixth in the search result list for arriving at the destination g₃ ends at the stopover w₁ in the method of Japanese Patent Application No. 2009-208064 shown in the “related art”. However, according to the prediction system 1, it is possible not to end at the stopover w₁ but to search until the route which arrives at the destination g₃ using the stopover w₁.

According to the prediction system 1, it is possible to resolve the first and second problems by distinguishing between the destinations and the stopovers and applying the attribute to the state nodes obtained by learning.

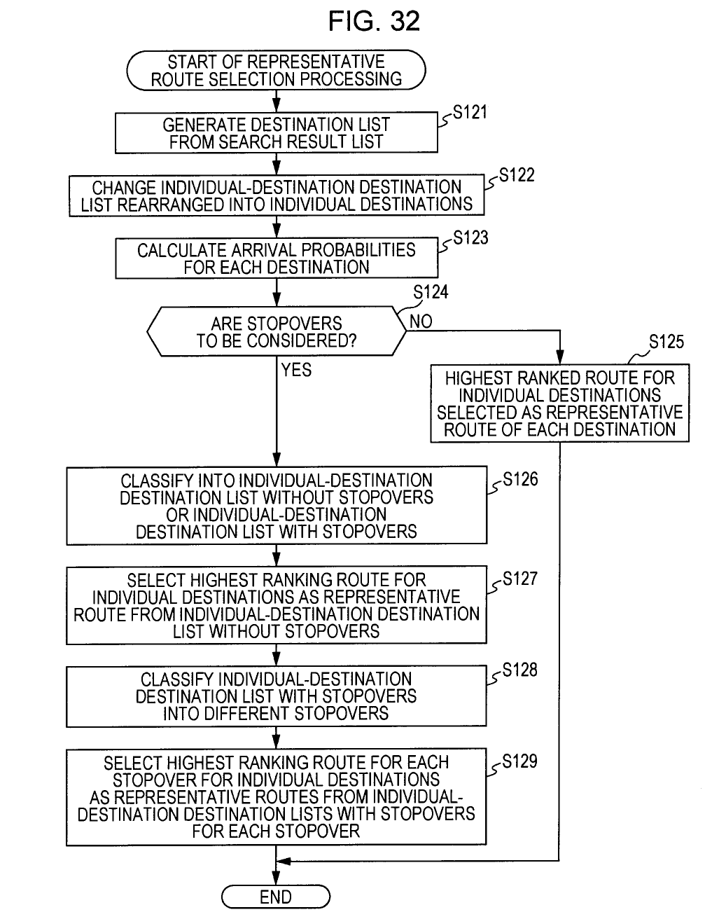

FIG. 32 is a flow chart of the representative route selection processing performed by the prediction post-process section 34.

Firstly, in step S121, the prediction post-process section 34 removes the routes to the stopovers from the search result list formed in the destination and stopover prediction section 42 and generates a destination list which is the search result list of only the destinations.

In step S122, the prediction post-process section 34 changes an individual-destination destination list where the destination list is rearranged into individual destinations. At this time, the prediction post-process section 34 generates the individual-destination destination list so that order does not change for the same destination.

In step S123, the prediction post-process section 34 calculates the arrival probability for each of the destinations. In a case where there is only one route to the destination, the route selection probability is the arrival probability, and in a case where there is a plurality of routes to the destination, the total of the plurality of selection probabilities (occurrence probabilities) is the arrival probability of the destination.

In step S124, the prediction post-process section 34 determines if the stopovers are to be considered in the selection of the representative route. In a case where it is determined that the stopovers are not to be considered in step S124, the processing progresses to step S125, and the prediction post-process section 34 selects the route with the highest ranking for the individual destinations as the representative routes of each of the destinations and the processing ends. As a result, in the case where there is the plurality of routes to the destination, the route to the destination with the highest selection probability is the representative route for each of the destinations, and the necessary time is presented as the necessary time to the destination. Here, in a case where there is a plurality of destinations, it is possible to set so that only the number of destinations set in advance from the top rank is presented.

On the other hand, a case where it is determined that the stopovers are to be considered in step S124, the processing progresses to step S126 and the prediction post-process section 34 classifies the individual-destination destination list into an individual-destination destination list without stopovers and an individual-destination destination list with stopovers.

Then, in step S127, the prediction post-process section 34 selects the route with the highest ranking for the individual destinations as the representative routes from the individual-destination destination list without stopovers. According to this, the route without stopovers is determined as the representative route for each destination.

Next, in step S128, the prediction post-process section 34 further classifies the individual-destination destination list with stopovers into different stopovers.

In step S129, the prediction post-process section 34 selects the route with the highest ranking of each stopover for the individual destinations as the representative routes from the individual-destination destination lists with stopovers for each stopover. According to this, the route with stopovers is determined as the representative route for each destination. As a result, in a case where there is the route without the stopover and the route with the stopover as the route to the destination, both are set as representative routes to each destination and the necessary time of each are presented as the necessary time to the destination.

Due to the above, the representative route selection processing ends. In this manner, in the case where there is the plurality of routes to the destination, it is possible that the presenting classified by stopovers is closer to the prediction that is actually sensed by the user than plural presentations of the top ranked occurrence probabilities.

Processing of Entire Prediction Block 13

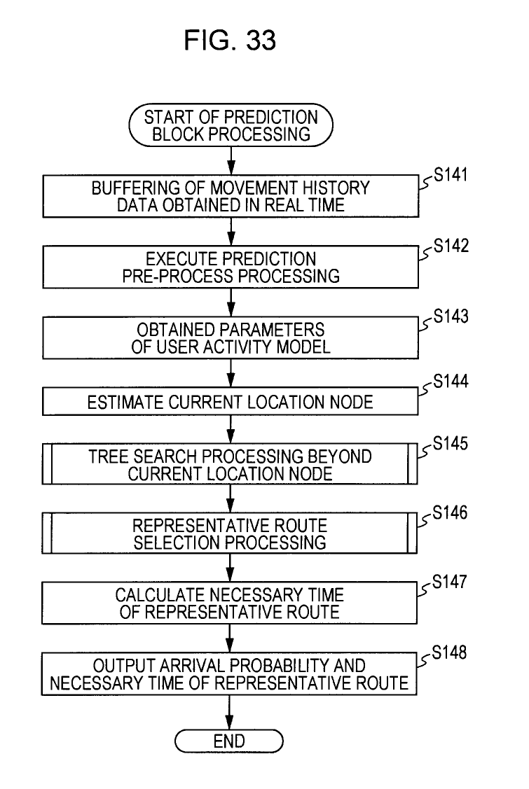

Processing of the entire prediction block 13 will be described with reference to the flow chart of FIG. 33.

First, in step S141, the buffering section 31 buffers the movement history data obtained in real time for the prediction processing.

In step S142, the prediction pre-process section 32 executes prediction pre-process processing. Specifically, in the same manner as the learning pre-process processing performed by the learning pre-process section 22, processing of the connection and division of the movement history data, processing of the removal of obvious abnormalities of the movement history data, and processing of supplementing the missing data is executed. Here, the stationary threshold time which is the standard when dividing up the movement history data may be a time different from the learning pre-process processing.

In step S143, the prediction main process section 33 obtains the parameters of the user activity model obtained by the learning of the learning block 11 from the individual user model parameter memory section 12. The processing where the parameters are obtained may be executed in advance separately to the processing where the destination of FIG. 33 is predicted.

In step S144, the current location node estimation section 41 of the prediction main process section 33 estimates the state node which corresponds to the current location of the user (current location node) using the user activity model obtained by the learning of the learning block 11. More specifically, the current location estimation section 41 calculates the state node series data which corresponds to the movement history data using the user activity model obtained by the learning of the learning block 11. Then, the current location node estimation section 41 sets the last state node in the state node series data as the current location node. In the calculation of the state node series data, a Viterbi algorithm is adopted.

In step S145, the destination and stopover prediction section 42 of the prediction main process section 33 executes the tree search processing beyond the current location node described with reference to FIG. 28. At the same time as the tree search processing, the occurrence probabilities of the routes (node series) to the destinations and the stopovers are also determined using equation (13).

In step S146, the prediction post-process section 34 executes the representative route selection processing described with reference to FIG. 32.

In step S147, the prediction post-process section 34 calculates the necessary time for each of the selected representative routes using the equation (15) described above.

In step S148, the prediction post-process section 34 outputs the representative routes, the arrival probabilities, and the necessary time to the predicted destination as the prediction result and the processing ends.

As above, in the processing of the prediction block 13, the route to the destination from the current location of the user is searched using the information on the estimated destination nodes and stopover nodes and the current location node and the user activity model obtained by learning. Since the attribute of the destination or the stopover is applied to the state nodes obtained by learning, it is possible to prevent the stopover being predicted as the destination.

In addition, since the attribute of the destination or the stopover is applied to the state nodes obtained by learning, it is possible to output the route without the stopovers or the route with the stopovers as the representative routes even if the routes are routes to the same destination.

Configuration Example of Computer

The series of processing described above is able to be executed using hardware or is able to be executed using software. In a case where the series of processing is executed using software, a program which configures the software is installed in a computer. Here, as the computer, a computer where specialized hardware is built in, a general-purpose personal computer, where it is possible to execute various functions by installing various programs, and the like are included.

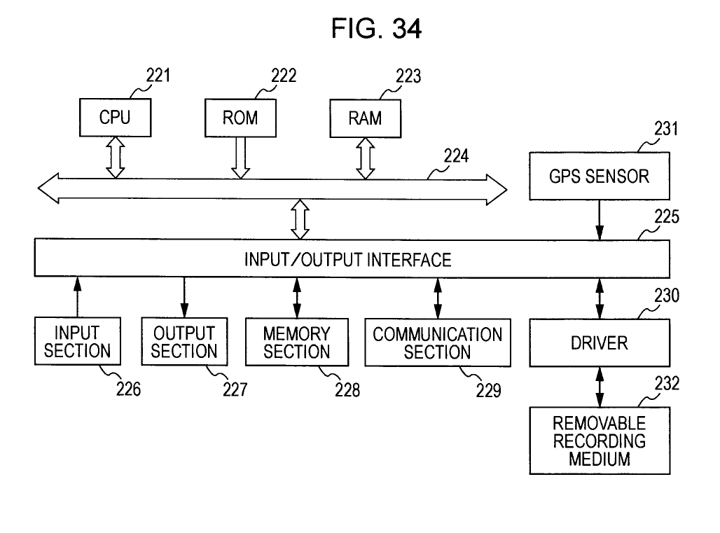

FIG. 34 is a block diagram illustrating a hardware configuration example of a computer which executes the series of processing described above as a program.

In the computer, a CPU (Central Processing Unit) 221, a ROM (Read Only Memory) 222, and a RAM (Random Access Memory) 223 are connected to each other by a bus 224.

In the bus 224, an input/output interface 225 is further connected. In the input/output interface 225, an input section 226, an output section 227, a memory section 228, a communication section 229, a driver 230, and a GPS sensor 231 are connected.

The input section 226 is formed by a keyboard, a mouse, a microphone, or the like. The output section 227 is formed by a display, speaker, or the like. The memory section 228 is formed by a hard disk, a non-volatile memory, or the like. The communication section 229 is formed by a network interface or the like. The driver 230 drives a removable recording medium 232 such as a magnetic disk, an optical disc, a magneto-optical disc, a semiconductor memory, or the like. The GPS sensor 231 as the sensor device described above outputs the current location position (latitude and longitude) data and the three-dimensional data at that point in time.

In the computer which is configured as above, the series of processing described above is performed by the CPU 221 loading the program stored in, for example, the memory section 228 into the RAM 223 via the input/output interface 225 and the bus 224 and executing the program.

It is possible that the program which is executed in the computer (CPU 221) is provided, for example, as recorded on the removable recording medium 232 as a package media or the like. In addition, it is possible that the program is provided via a wired or wireless transmission medium such as a local area network, the internet, or digital satellite broadcasting.

In the computer, it is possible that the program is installed in the memory section 228 via the input/output interface 225 by mounting the removable recording medium 232 in the driver 230. In addition, it is possible that the program is received by the communication section 229 and installed in the memory section 228 via the wired or wireless transmission medium. Otherwise, it is possible that the program is installed in advance in the ROM 222 or the memory section 228.

Here, the program which is executed by the computer may be a program where the processing is performed in a time series in the order described in the embodiment, or may be a program where the processing is performed in series or at a necessary timing such as when a request is performed.

Here, in the embodiment, the steps described in the flow charts may of course be performed in a time series in the described order and are not necessarily performed in a time series but may be executed in series or at a necessary timing such as when a request is performed.

Here, in the embodiment, the system represents the entire device which is configured by the plurality of devices.

The present application contains subject matter related to that disclosed in Japanese Priority Patent Application JP 2010-128068 filed in the Japan Patent Office on Jun. 3, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data processing device comprising:
a learning means which expresses user movement history data obtained as learning data as a probability model which expresses activities of a user and learns parameters of the model;
a destination and stopover estimation means which estimates a destination node and a stopover node which are equivalent to a destination and a stopover of a movement from state nodes of the probability model which uses the parameters obtained by learning;
a current location estimation means which inputs the user movement history data, which is different to the learning data and is within a predetermined time from the current time, in the probability model which uses the parameters obtained by learning and estimates a current location node which is equivalent to the current location of the user;
a searching means which searches for a route from the current location of the user to a destination using information on the estimated destination node and stopover node and the current location node and the probability model obtained by learning; and
a calculating means which calculates an arrival probability and a necessary time to the searched destination.

2. The data processing device according to claim 1, further comprising:
a movement attribute distinguishing means which distinguishes at least a stationary state and a movement state with regard to each unit of three-dimensional data which configures the movement history data,
wherein, the destination and stopover estimation means estimates the state node, which corresponds to the movement history data where the stationary state has continued for a predetermined threshold time or more, as the destination node, and estimates the state node, which corresponds to the movement history data where continuous time of the stationary state is less than the predetermined threshold time, as the stopover node.

3. The data processing device according to claim 2, further comprising:
a data working means which corrects the movement history data where the stationary state has continued for the predetermined threshold time or more as data of the same position,
wherein the learning means learns parameters of the probability model using the learning data worked using the data working means.

4. The data processing device according to claim 1,
wherein the learning means adopts a hidden Markov model as a probability model which expresses activities of the user and learns the parameters so that a likelihood is maximized when the movement history data is modeled using the hidden Markov model.

5. The data processing device according to claim 1,
wherein the current location estimation means calculates state node series data of the probability model which uses the parameters obtained by learning and which corresponds to the movement history data of the user within a predetermined time from the current time, and sets the last node in the calculated state node series data as a node equivalent to the current location of the user.

6. The data processing device according to claim 1,
wherein, in a tree structure which is formed by the state nodes for which it is possible to transition to from the current location node of the user, the searching means searches all of the state nodes with the current location node as a start point to the destination node or to terminal nodes where there is no transition destination or searches until the number of searches reaches a predetermined number of times which is a completion condition, and determines a route from the current location of the user to the destination as a state node series from the current location node.

7. The data processing device according to claim 6,
wherein the searching means executes processing using a depth priority algorithm which searches from the routes of branches with a higher selection probability.

8. The data processing device according to claim 1,
wherein the calculating means calculates a selection probability of a route to the destination by calculating joint probabilities of standardized transition probabilities of the state node series to the searched destination node.

9. The data processing device according to claim 8,
wherein, in a case where there are a plurality of routes to the destination, the calculating means calculates an arrival probability to the destination using the total of a plurality of the selection probabilities.

10. The data processing device according to claim 8,
wherein the calculating means calculates a route with the highest selection probability for individual destinations, out of the routes from the current location of the user to the destination in a search result, as a representative route for each of the destinations, and the necessary time thereof as the necessary time to the destination.

11. The data processing device according to claim 8,
wherein, in a case where there is a route without a stopover and a route with a stopover as the routes to the destination, the calculating means calculates the both as representative routes to each destination and the necessary times of each route as the necessary times to the destination.

12. The data processing device according to claim 1,
wherein the calculating means calculates the necessary time to the destination as an expected value of the time from the current point in time to when moving to the destination node at the state node immediately before the destination node.

13. A data processing method of a data processing device which processes movement history data of a user comprising the steps of:
expressing the movement history data obtained as learning data as a probability model which expresses activities of a user and learning parameters of the model;
estimating a destination node and a stopover node which are equivalent to a destination and a stopover of a movement from state nodes of the probability model which uses the parameters obtained by learning;
inputting the user movement history data, which is different to the learning data and is within a predetermined time from the current time, in the probability model which uses the parameters obtained by learning and estimating a current location node which is equivalent to the current location of the user;
searching for a route from the current location of the user to a destination using information on the estimated destination node and stopover node and the current location node and the probability model obtained by learning; and
calculating an arrival probability and a necessary time to the searched destination.

14. A program which causes a computer function as:
a learning means which expresses user movement history data obtained as learning data as a probability model which expresses activities of a user and learning parameters of the model;
a destination and stopover estimation means which estimates a destination node and a stopover node which are equivalent to a destination and a stopover of a movement from state nodes of the probability model which uses the parameters obtained by learning;
a current location estimation means which inputs the user movement history data, which is different to the learning data and is within a predetermined time from the current time, in the probability model which uses the parameters obtained by learning and estimating a current location node which is equivalent to the current location of the user;
a searching means which searches for a route from the current location of the user to a destination using information on the estimated destination node and stopover node and the current location node and the probability model obtained by learning; and
a calculating means which calculates an arrival probability and a necessary time to the searched destination.

15. A data processing device comprising:
a learning section which expresses user movement history data obtained as learning data as a probability model which expresses activities of a user and learns parameters of the model;
a destination and stopover estimation section which estimates a destination node and a stopover node which are equivalent to a destination and a stopover of a movement from state nodes of the probability model which uses the parameters obtained by learning;
a current location estimation section which inputs the user movement history data, which is different to the learning data and is within a predetermined time from the current time, in the probability model which uses the parameters obtained by learning and estimates a current location node which is equivalent to the current location of the user;
a searching section which searches for a route from the current location of the user to a destination using information on the estimated destination node and stopover node and the current location node and the probability model obtained by learning; and
a calculating section which calculates an arrival probability and a necessary time to the searched destination.
